(19) United States
(12) Patent Application Publication
(10) Pub. No.: US 2023/0299974 A1
(43) Pub. Date: Sep. 21, 2023

(54) DISPLAY APPARATUS, METHOD FOR GENERATING ELECTRONIC SIGNATURE, AND ELECTRONIC SIGNATURE SYSTEM

(71) Applicant: Kiwamu Watanabe, KANAGAWA (JP)

(72) Inventor: Kiwamu Watanabe, KANAGAWA (JP)

(73) Assignee: Ricoh Company, Ltd., Tokyo (JP)

(21) Appl. No.: 18/178,846

(22) Filed: Mar. 6, 2023

(30) Foreign Application Priority Data
Mar. 18, 2022 (JP) 2022-044209
Nov. 30, 2022 (JP) 2022-192220

(51) Int. Cl. H04L 9/32; G06V 30/18

(52) U.S. Cl. CPC H04L 9/3247; G06V 30/18019; H04L 9/3297

(57) ABSTRACT

A display apparatus includes circuitry to receive an input of hand drafted input data displayed as an object on a display. The circuitry converts the hand drafted input data into one of a text and a shape and determines whether the one of the text and the shape corresponds to a corresponding one of a recognition character string and a recognition shape set in advance. In a case that the one of the text and the shape corresponds to the corresponding one of the recognition character string and the recognition shape, the circuitry displays a display component based on the corresponding one of the recognition character string and the recognition shape. The display component is for receiving a user operation for generating an electronic signature in relation to the object. The circuitry generates the electronic signature in response to receiving selection of the display component.

### CROSS-REFERENCE TO RELATED APPLICATIONS

This patent application is based on and claims priority pursuant to 35 U.S.C. § 119(a) to Japanese Patent Application Nos. 2022-044209, filed on Mar. 18, 2022, and 2022-192220, filed on Nov. 30, 2022, in the Japan Patent Office, the entire disclosures of which are hereby incorporated by reference herein.

### BACKGROUND

### Technical Field

Embodiments of the present disclosure relate to a display apparatus, a method for generating an electronic signature, and an electronic signature system.

### Related Art

Known display apparatuses convert handwriting data or hand drafted input data into text such as a character and display the text on a display by using a character recognition technique. Such a display apparatus having a relatively large touch panel is used as, for example, an electronic whiteboard by a plurality of users in a conference room or a public facility.

A technique for generating authentication data using hand drafted input data has been devised. According to a related art, signature data input by hand drafted input to a signature input field is received, and authentication data available for user authentication is stored.

### SUMMARY

An embodiment of the present disclosure includes a display apparatus including circuitry to receive an input of hand drafted input data. The hand drafted input data is displayed as an object on a display. The circuitry converts the hand drafted input data into one of a text and a shape and determines whether the one of the text and the shape corresponds to a corresponding one of a recognition character string and a recognition shape. The recognition character string and the recognition shape are set in advance. In a case that the one of the text and the shape corresponds to the corresponding one of the recognition character string and the recognition shape, the circuitry displays a display component based on the corresponding one of the recognition character string and the recognition shape. The display component is for receiving a user operation for generating an electronic signature in relation to the object. The circuitry generates the electronic signature in response to receiving selection of the display component.

An embodiment of the present disclosure includes a method for generating an electronic signature. The method includes receiving an input of hand drafted input data. The hand drafted input data is displayed as an object on a display. The method further includes converting the hand drafted input data into one of a text and a shape, and determining whether the one of the text and the shape corresponds to a corresponding one of a recognition character string and a recognition shape. The recognition character string and the recognition shape are set in advance. The method further includes displaying, in response to determining that the one of the text and the shape corresponds to the corresponding one of the recognition character string and the recognition shape, a display component based on the corresponding one of the recognition character string and the recognition shape. The display component is for receiving a user operation for generating an electronic signature in relation to the object. The method further includes generating the electronic signature in response to receiving selection of the display component.

An embodiment of the present disclosure includes an electronic signature system including a display apparatus and an electronic signature server including display apparatus circuitry communicably connected to each other. The display apparatus includes display apparatus circuitry, and the electronic signature server includes electronic signature server circuitry. The display apparatus circuitry receives an input of hand drafted input data. The hand drafted input data is displayed as an object on a display. The display apparatus circuitry converts the hand drafted input data into one of a text and a shape, and determines whether the one of the text and the shape corresponds to a corresponding one of a recognition character string and a recognition shape. The recognition character string and the recognition shape are set in advance. The display apparatus circuitry displays, in response to determining that the one of the text and the shape corresponds to the corresponding one of the recognition character string and the recognition shape, a display component based on the corresponding one of the recognition character string and the recognition shape. The display component is for receiving a user operation for generating an electronic signature in relation to the object. The display apparatus circuitry transmits, to the electronic signature server, a request for generation of the electronic signature, in response to receiving selection of the display component. The electronic signature server circuitry generates the electronic signature in response to receiving the request transmitted from the display apparatus.

### BRIEF DESCRIPTION OF THE DRAWINGS

A more complete appreciation of embodiments of the present disclosure and many of the attendant advantages and features thereof can be readily obtained and understood from the following detailed description with reference to the accompanying drawings, wherein:

FIG. 1A and FIG. 1B are diagrams illustrating an electronic signature added to stored data that is stored by a display apparatus, according to a first embodiment of the disclosure;

FIGS. 2A to 2F are diagrams illustrating a process performed by the display apparatus for generating an electronic signature according to the first embodiment of the disclosure;

FIG. 3 is a block diagram illustrating an example of a configuration of a display system according to the first embodiment of the disclosure;

FIG. 4 is a block diagram illustrating an example of a hardware configuration of the display apparatus according to the first embodiment of the disclosure;

FIG. 5 is a block diagram illustrating a hardware configuration of a computer according to the first embodiment of the disclosure;

FIG. 6 is a block diagram illustrating an example of functional configurations of the display apparatus and a terminal device according to the first embodiment of the disclosure;

FIG. 7 is a diagram schematically illustrating an example of information on objects stored in an object storage unit according to the first embodiment of the disclosure;

FIG. 8 is a diagram schematically illustrating an example of command definition data stored in a command definition data storage unit according to the first embodiment of the disclosure;

FIG. 9 is a diagram schematically illustrating an example of electronic signature information stored in an electronic signature information storage unit according to the first embodiment of the disclosure;

FIG. 10 is a diagram illustrating an example of an electronic signature information registration screen displayed by the terminal device according to the first embodiment of the disclosure;

FIG. 11 is a flowchart illustrating an example of a process performed by the display apparatus for receiving registration of electronic signature information according to the first embodiment of the disclosure;

FIG. 12A is a diagram illustrating an example of an electronic signature information list screen according to the first embodiment of the disclosure;

FIG. 12B is a diagram illustrating an example of a confirmation message according to the first embodiment of the disclosure;

FIG. 13 is a flowchart illustrating an example of a process performed by the display apparatus for receiving an operation for deleting the electronic signature information according to the first embodiment of the disclosure;

FIGS. 14A to 14F are diagrams illustrating transition of information displayed in relation to a signature input field according to the first embodiment of the disclosure;

FIG. 15 is a flowchart illustrating an example of a process performed by the display apparatus for generating an electronic signature in response to hand drafted input performed to the signature input field according to the first embodiment of the disclosure;

FIG. 16 is a flowchart illustrating an example of a process performed by an electronic signature unit for determining whether text of a signer is input to the signature input field, according to the first embodiment of the disclosure;

FIG. 17A is a diagram illustrating an example of an operation guide including an operation command for displaying the signature input field, according to the first embodiment of the disclosure;

FIG. 17B is a diagram illustrating an example of the input field, according to the first embodiment of the disclosure;

FIG. 18 is a flowchart illustrating an example of a process performed by the display apparatus for newly displaying the signature input field, according to the first embodiment of the disclosure;

FIGS. 19A and 19B are diagrams illustrating an operation command for generating an electronic signature to be displayed by the display apparatus without using the signature input field, according to the first embodiment of the disclosure;

FIG. 20 is a flowchart illustrating an example of a process performed by the display apparatus for generating an electronic signature without using the signature input field, according to the first embodiment of the disclosure;

FIG. 21 is a block diagram illustrating an example of a system configuration when the display apparatus 2 uses a time stamp server according to a second embodiment of the disclosure;

FIG. 22 is a diagram illustrating an example of a uniform resource locator (URL) setting screen displayed by the terminal device when a user sets the URL of the time stamp server to the display apparatus, according to the second embodiment of the disclosure;

FIG. 23 is a flowchart illustrating an example of a process performed by the display apparatus for receiving settings for the URL of the time stamp server according to the second embodiment of the disclosure;

FIG. 24 is a flowchart illustrating an example of a process performed by the display apparatus for generating an electronic signature of which the processing includes adding a time stamp according to the second embodiment of the disclosure;

FIG. 25 is a block diagram illustrating an example of a system configuration of an electronic signature system according to a third embodiment of the disclosure;

FIG. 26 is a block diagram illustrating an example of functional configurations of a display apparatus, an electronic signature server, and a terminal device according to a third embodiment of the disclosure;

FIG. 27 is a diagram schematically illustrating an example of electronic signature identification information stored in an electronic signature identification information storage unit according to the third embodiment of the disclosure;

FIG. 28 is a sequence diagram illustrating an example of a process performed by the electronic signature system for generating an electronic signature in response to a request from the display apparatus according to the third embodiment of the disclosure;

FIG. 29 is a block diagram illustrating an example of functional configurations of a display apparatus and a terminal device according to a fourth embodiment of the disclosure;

FIG. 30 is a diagram illustrating an example of an electronic signature information registration screen according to the fourth embodiment of the disclosure;

FIGS. 31A to 31C are diagrams illustrating an example of an operation command displayed by the display apparatus at the time of login, according to the fourth embodiment of the disclosure;

FIGS. 32A and 32B are diagrams illustrating another example of an operation command displayed by the display apparatus at the time of login, according to the fourth embodiment of the disclosure;

FIG. 33 is a diagram illustrating an example of an input screen displayed by the display apparatus according to the fourth embodiment of the disclosure;

FIGS. 34A and 34B are diagrams illustrating examples of a signature execution dialog and a message, according to the fourth embodiment of the disclosure;

FIG. 35 is a flowchart illustrating an example of a process performed by the display apparatus for generating an electronic signature, according to the fourth embodiment of the disclosure;

FIG. 36 is a block diagram illustrating an example of functional configurations of a display apparatuses and a terminal device according to a fifth embodiment of the disclosure;

FIG. 37 is a flowchart illustrating an example of a process performed by the display apparatus for automatically generating an electronic signature, according to the fifth embodiment of the disclosure;

FIG. 38 is a block diagram illustrating a system configuration of a remote communication system according to a sixth embodiment of the disclosure;

FIG. 39 is a block diagram illustrating a functional configuration of a relay server according to the sixth embodiment of the disclosure;

FIG. 40 is a sequence diagram illustrating an example of a process for sharing an object and an electronic signature by a plurality of display apparatuses according to the sixth embodiment of the disclosure;

FIG. 41 is a diagram schematically illustrating an example of command definition data stored in a command definition data storage unit according to a seventh embodiment of the disclosure;

FIG. 42 is a diagram illustrating an example of a signature execution command according to the seventh embodiment of the disclosure; and

FIG. 43 is a flowchart illustrating an example of a process performed by the display apparatus for generating an electronic signature and storing the electronic signature in a universal serial bus (USB) memory.

The accompanying drawings are intended to depict embodiments of the present disclosure and should not be interpreted to limit the scope thereof. The accompanying drawings are not to be considered as drawn to scale unless explicitly noted. Also, identical or similar reference numerals designate identical or similar components throughout the several views.

### DETAILED DESCRIPTION

In describing embodiments illustrated in the drawings, specific terminology is employed for the sake of clarity. However, the disclosure of this specification is not intended to be limited to the specific terminology so selected and it is to be understood that each specific element includes all technical equivalents that have a similar function, operate in a similar manner, and achieve a similar result.

Referring now to the drawings, embodiments of the present disclosure are described below. As used herein, the singular forms “a,” “an,” and “the” are intended to include the plural forms as well, unless the context clearly indicates otherwise.

A display apparatus and an electronic signature method performed by the display apparatus according to one or more embodiments of the present disclosure are described with reference to the attached drawings.

### First Embodiment

Overview of Electronic Signature

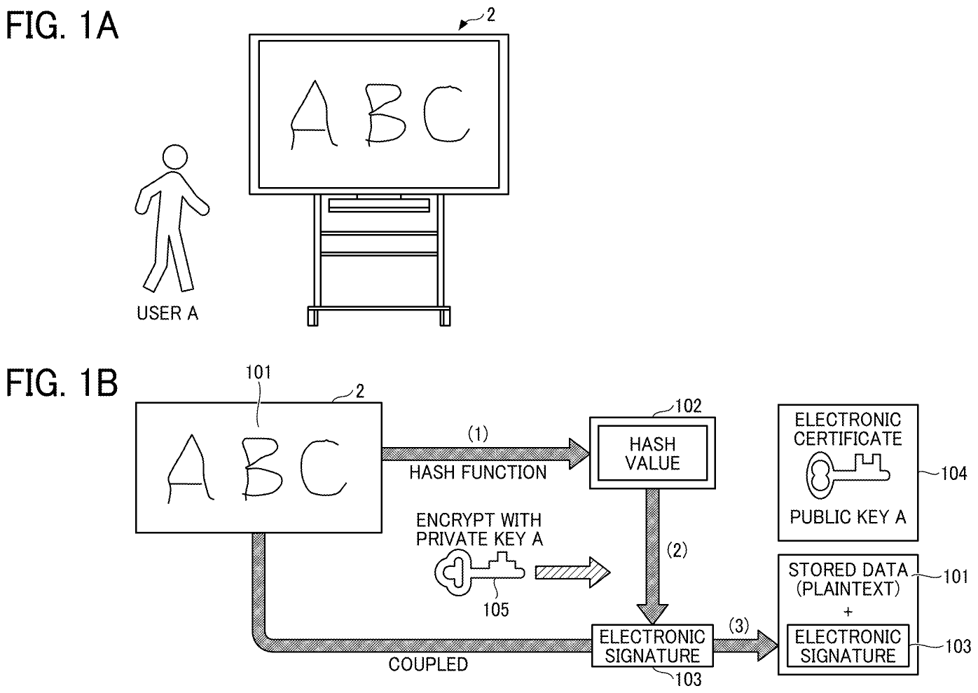

A description is given below of an electronic signature with reference to FIG. 1A and FIG. 1B. FIG. 1A and FIG. 1B are diagrams illustrating an electronic signature added to stored data that is stored by a display apparatus 2, according to a first embodiment. As illustrated in FIG. 1A, a user A inputs “ABC” by handwriting input, or hand drafted input. The data representing “ABC” may be stored as the coordinate point sequence, or may be stored in a file such as portable document format (PDF).

FIG. 1B illustrates a process for generating an electronic signature. In response to a user operation performed by the user A for adding an electronic signature to stored data 101 (“ABC”), the display apparatus 2 generates the electronic signature in a procedure as follows. The user A has already obtained his or her private key and an electronic certificate for a public key corresponding to the private key from a certificate authority.
(1) The display apparatus 2 converts the stored data 101 by a hash function to generate a hash value 102. The stored data 101 is electronic data.
(2) The display apparatus 2 encrypts the hash value 102 with a private key 105 corresponding to the public key certified by the electronic certificate. This operation is referred to as generating an electronic signature 103 and the data generated by this operation is referred to as the electronic signature 103. Any of various encryption algorithms, such as “data encryption standard (DES),” “Rivest's Cipher 4 (RC4),” and “advanced encryption standard (AES)” is applicable.
(3) The display apparatus 2 combines the stored data 101 (plaintext) and the electronic signature 103, and stores the combined data together with the electronic certificate 104.

In order for the user A to confirm that the stored data 101 has not been falsified, the display apparatus 2 generates a hash value based on the stored data 101 using the same hash function. The display apparatus 2 decrypts the electronic signature 103 with the public key to obtain the hash value 102. When the two hash values match, the facts that the stored data has not been falsified and the stored data is the data stored by the user A are confirmed.

Overview of Electronic Signature in Display Apparatus

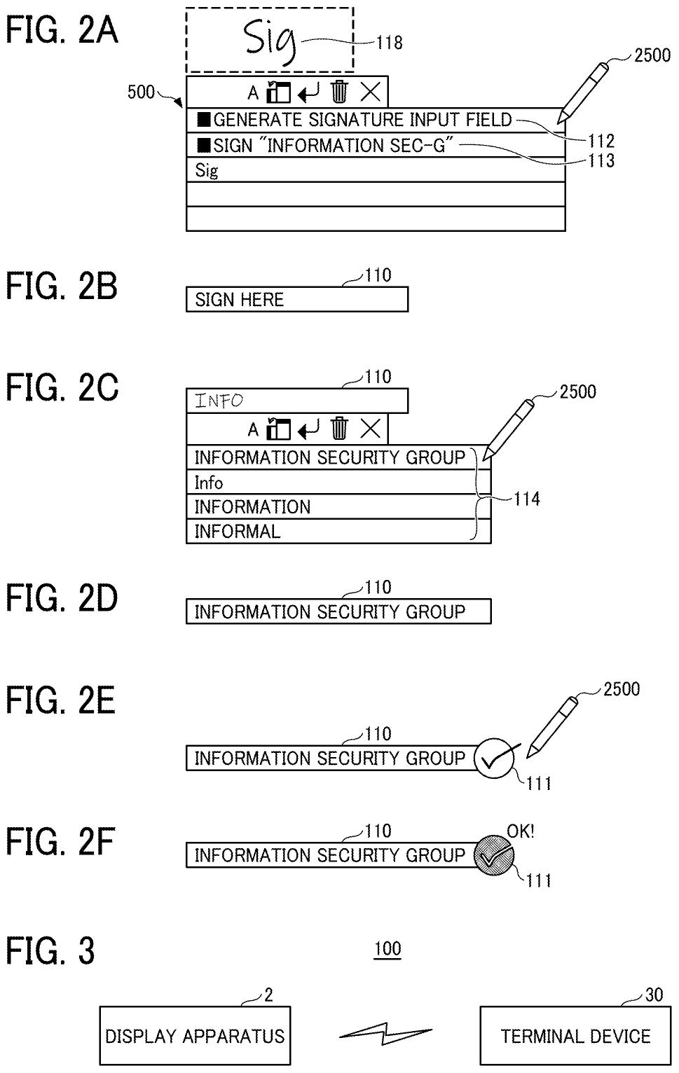

An overview of the electronic signature in the display apparatus 2 is described with reference to FIGS. 2A to 2F. FIGS. 2A to 2F are diagrams illustrating a process performed by the display apparatus 2 for generating an electronic signature according to the present embodiment. The process illustrated in FIG. 2 is an example, and the process can be different depending on the presence or absence of a signature input field 110 (an example of an input field) and the presence or absence of registration for a private key and a public key, for example.

As illustrated in FIG. 2A, in order to display the signature input field 110, a user who is to add the electronic signature inputs hand drafted input data 118 for displaying a signature input field generation command 112. In FIG. 2A, “Sig” that is input by hand drafted input partially matches a recognition character string (for example, Signature) in command definition data, which is described later. Accordingly, the signature input field generation command 112 that is “GENERATE SIGNATURE INPUT FIELD” and a signature execution command 113 that is “SIGN INFORMATION SEC-G” are displayed in an operation guide 500.

Additional description of the operation guide 500 is given below. The operation guide 500 displays a result of recognition on hand drafted input data (text) and text that is predictively converted (character string candidate 114 displayed in the operation guide). A character string selected from among one or more character string candidates with the operation guide 500 is replaced with the hand drafted input data and displayed. Various operation commands may be displayed with the operation guide 500 based on the command definition data. In the present embodiment, there is a case that an electronic signature is generated by selecting an operation command. A black box at the head of each of the signature input field generation command 112 and the signature execution command 113 indicates that the command is not one of the character string candidates 114, but a command.

As illustrated in FIG. 2B, when the user selects the signature input field generation command 112 with a pen 2500, the display apparatus 2 displays a signature input field 110. In the signature input field 110, placeholder text of “SIGN HERE” is displayed. The placeholder text is an explanatory text that is displayed inside until being touched.

When the user selects the signature execution command 113 with the pen 2500 in FIG. 2A, the display apparatus 2 generates an electronic signature using electronic signature information associated with “INFORMATION SEC-G”. In this case, the subsequent processing is unnecessary.

As illustrated in FIG. 2C, in order to call up the electronic signature information associated with the user, the user performs hand drafted input to the signature input field 110. In the description of the present embodiment, the user is a member of an information security group, and the electronic signature information associated with the information security group is to be used. The user performs hand drafted input to input “INFO,” for example. The display apparatus 2 displays several character string candidates 114 by performing character recognition on “INFO.” The character string candidate 114 is a text obtained by converting “INFO,” and includes a character string predictively converted from the text. In a case of Japanese, a Chinese character may be included in the character string candidate predictively converted from Hiragana input by hand drafted input.

As illustrated in FIG. 2D, when the user uses the electronic signature information associated with the information security group, the user selects “INFORMATION SECURITY GROUP” is selected as one of the character string candidates 114 with the pen 2500 in FIG. 2C. The display apparatus 2 displays “INFORMATION SECURITY GROUP” in the signature input field 110. The name of the group to which the user belongs is an example of the signature added to the stored data, and, needless to say, the signature may be the name of the signer.

As illustrated in FIG. 2E, in response to the text “information security group” being input to the signature input field 110, the display apparatus 2 determines whether the text (INFORMATION SECURITY GROUP) is associated with electronic signature information or not. When the electronic signature information is associated with the text input to the signature input field 110, the display apparatus 2 displays a check mark 111 in relation to the signature input field 110. As described above, the check mark 111 is an indication that that the electronic signature is available.

As illustrated in FIG. 2F, when the user touches the check mark 111 with the pen 2500, the display apparatus 2 inverts, for example, inverts colors of, the check mark 111 and generates an electronic signature.

As described above, the display apparatus 2 according to the present embodiment can generate the signature input field 110 and add a signature by input with a pen. Since the user can use the text converted from the hand drafted input data simply for input or can select the signature execution command 113 to generate an electronic signature, the user does not need to switch between a mode for input of text and a mode for generation of an electronic signature. Executing the command allows the user to generate an electronic signature easily without decreasing work efficiency. With this configuration, hand drafted input for an operation for inputting text or a shape and hand drafted input being for operation of generating an electronic signature are selectable to be performed.

What the user inputs by hand drafted input is not limited to text. In addition to conversion from the hand drafted input data to the text, the hand drafted input data may be converted to a shape. When the converted shape matches a preset recognition shape for generating an electronic signature, the signature execution command 113 may be displayed to receive selection from the user.

### Terms

“Input device” refers to any devices with which a user hand drafted input can be performed by designating coordinates on a touch panel. Examples thereof include a pen, a human finger, a human hand, and a bar-shaped member.

A series of user operations including engaging a writing mode, recording movement of an input device or portion of a user, and then disengaging the writing mode is referred to as a stroke. A stroke includes tracking movement of the portion of the user without contacting a display or screen. In this case, the writing mode may be engaged or turned on by a gesture of a user, pressing a button by a hand or a foot of the user, or otherwise turning on the writing mode, for example using a pointing device such as a mouse. The engaging of the writing mode may include, if desired, pressing an input device against a display or screen, and disengaging the writing mode may include releasing the input device from the display or screen. The disengaging of the writing mode can be accomplished by the same or different gesture used to engage the writing mode, releasing the button, or otherwise turning off the writing mode, for example using the pointing device or mouse.

“Stroke data” is information that is displayed on a display based on a trajectory of coordinates input with the input device. The stroke data may be interpolated appropriately. In the description of embodiments, “hand drafted input data” refers to data having one or more pieces of stroke data. In the present disclosure, a “hand drafted input” relates to a user input such as handwriting, drawing, and other forms of input. The hand drafted input may be performed via touch interface, with a tactile object such as a pen or stylus or with the user's body. The hand drafted input may also be performed via other types of input, such as gesture-based input, hand motion tracking input or other touch-free input by a user. The hand drafted input includes handwriting input. The following description may refer to hand drafted input and hand drafted input data, but other forms of hand drafted input may be utilized and are within the scope of the present disclosure.

“Object” refers to an item displayed on a screen.

The term “object” in this specification also represents an object to be displayed.

An “object” obtained by handwriting recognition or hand drafted recognition and conversion of stroke data may include, in addition to text, a stamp of a given character or mark such as “complete,” a shape such as a circle or a star, or a line. The text is a result of character recognition performed on the hand drafted input data. Data used for displaying an object is referred to as object data.

The electronic signature is data that certifies that an electronic document (stored data) belongs to a signer and that the content has not been falsified. A file or the like in which an object is stored is referred to as stored data.

The display component is indicated by a character, a shape, or the like related to an instruction so that an operation can be instructed by pointing and selecting the display component on a screen in a computer. In the description of embodiments, the display component may be described by using a term of an operation command.

The signer information is information that can specify or identify a signer. In the description of embodiments, a name of the signer is used as signer information, but the signer information may be information associated with a signer, such as a signer ID.

Examples of the “shape” include various shapes, outlines, contours, or line shapes, determined by a certain rule. Although there are many types of shapes such as triangle, quadrangle, circle, and rhombus, a shape for creating an electronic signature is set in advance.

The user can display a drawn shape as the shape or use the drawn shape to select for generating an electronic signature (the drawn shape used to select for generating an electronic signature is to be deleted). Accordingly, in the description of embodiments, whether a stroke is recognized as text or a shape is determined.

System Configuration

A configuration of a display system 100 is described with reference to FIG. 3. FIG. 3 is a block diagram illustrating an example of a configuration of the display system 100. The display system 100 includes the display apparatus 2, and the display apparatus 2 and a terminal device 30 communicate with each other by short-range wireless communication. The wireless communication method may be, for example, Wi-Fi (wireless LAN), BLUETOOTH, infrared communication, visible light communication, or integrated circuit (IC) card communication. In the case of Wi-Fi, the communication method may be an ad hoc mode or an infrastructure mode.

The display apparatus 2 displays data input by hand drafted input on a touch panel by an input device such as a pen or a finger on a display. The display apparatus 2 according to the present embodiment includes a large-sized display shared by a plurality of users in an office or a site, and may be used as an electronic whiteboard. The display apparatus 2 may be a device that includes a touch panel and a short-range wireless communication function. For example, the display apparatus 2 may be a tablet terminal, a laptop personal computer (PC), a personal digital assistant (PDA), or a game console.

The display apparatus 2 may be implemented by a projector and a whiteboard that does not include a touch panel. In this case, the projector detects the contact position of the input device using a camera or a sensor.

The display apparatus 2 displays a service set identifier (SSID) and a personal identification number (PIN) used by the terminal device 30 in the Wi-Fi communication, automatically or in response to a user operation. When the user inputs at least the PIN to the terminal device 30, the terminal device 30 can communicate with the display apparatus 2 by Wi-Fi.

The terminal device 30 is an information processing apparatus having a position detection function and a wireless communication function. In the terminal device 30, a web browser and a dedicated application are installed to communicate with the display apparatus 2. The user activates the web browser and the dedicated application to communicate with the display apparatus 2. The terminal device 30 can transmit setting information such as electronic signature information to the display apparatus 2.

Hardware Configuration

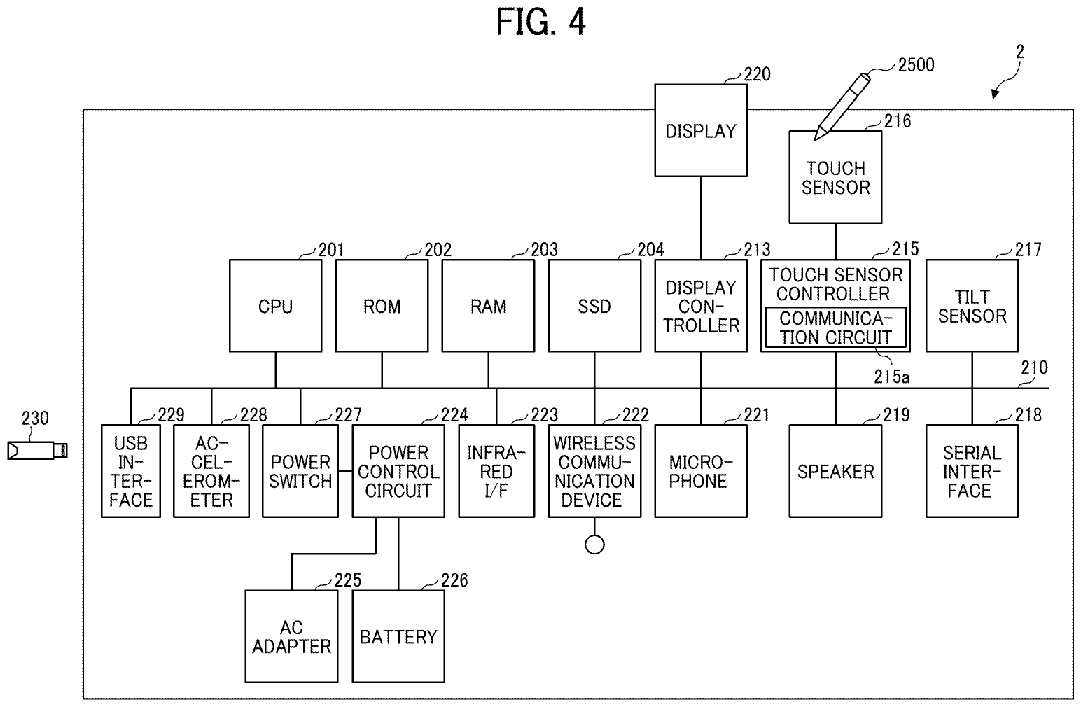

A hardware configuration of the display apparatus 2 according to the present embodiment is described with reference to FIG. 4. The display apparatus 2 has a configuration of an information processing apparatus or a computer as illustrated in FIG. 4. FIG. 4 is a block diagram illustrating an example of the hardware configuration of the display apparatus 2. As illustrated in FIG. 4, the display apparatus 2 includes a central processing unit (CPU) 201, a read only memory (ROM) 202, a random access memory (RAM) 203, and a solid state drive (SSD) 204.

The CPU 201 controls overall operation of the display apparatus 2. The ROM 202 stores a control program such as an initial program loader (IPL) to boot the CPU 201. The RAM 203 is used as a work area for the CPU 201.

The SSD 204 stores various data such as an operating system (OS) and a program for the display apparatus 2. The program may be an application program that runs on an information processing apparatus equipped with a general-purpose OS such as WINDOWS, MAC OS, ANDROID, and IOS. In this case, the display apparatus 2 is usually used as a general-purpose information processing apparatus. However, when a user executes an installed application program, the display apparatus 2 receives handwriting, or hand drafted input, performed by the user similarly to a dedicated display apparatus.

The display apparatus 2 further includes a display controller 213, a touch sensor controller 215, a touch sensor 216, a display 220, a power switch 227, a tilt sensor 217, a serial interface 218, a speaker 219, a microphone 221, a wireless communication device 222, an infrared interface (I/F) 223, a power control circuit 224, an alternating current (AC) adapter 225, a battery 226, an accelerometer 228, and a universal serial bus (USB) interface 229.

The display controller 213 controls display of an image output to the display 220. The touch sensor 216 detects that the pen 2500, a user's hand or the like is brought into contact with the display 220. The pen or the user's hand is an example of input device. The touch sensor 216 also receives a pen identifier (ID).

The touch sensor controller 215 controls processing of the touch sensor 216. The touch sensor 216 performs coordinate input and coordinate detection. A method of inputting and sensing coordinates is described. For example, in a case of optical sensing, two light receiving and emitting devices disposed on both upper side ends of the display 220 emit infrared ray (a plurality of lines of light) in parallel to a surface of the display 220. The infrared ray is reflected by a reflector provided around the display 220, and two light-receiving elements receive light returning along the same optical path as that of the emitted light.

The touch sensor 216 outputs position information of the infrared ray that is blocked by an object after being emitted from the two light receiving and emitting devices, to the touch sensor controller 215. Based on the position information of the infrared ray, the touch sensor controller 215 detects a specific coordinate that is touched by the object. The touch sensor controller 215 further includes a communication unit 215a for wireless communication with the pen 2500. For example, when communication is performed in compliance with a standard such as BLUETOOTH, a commercially available pen can be used. If one or more pens 2500 are registered to the communication unit 215a in advance, the display apparatus 2 and the pen 2500 communicates with each other without the user's manual operation of configuring connection settings between the pen 2500 and the display apparatus 2.

The power switch 227 turns on or off the power of the display apparatus 2. The tilt sensor 217 detects the tilt angle of the display apparatus 2. The tilt sensor 217 is mainly used to detect a state of the display apparatus 2 being used, for example whether the display apparatus 2 is used horizontally or vertically, or whether the display apparatus 2 is placed portrait or landscape. The display apparatus 2 can automatically change the thickness of characters or the like depending on the detected state.

The serial interface 218 is an interface to connect the display apparatus 2 to extraneous sources such as a USB.

The serial interface 218 is used to input information from extraneous sources. The speaker 219 is used to output sound, and the microphone 221 is used to input sound. The wireless communication device 222 communicates with a terminal carried by the user and relays the connection to the Internet, for example. The wireless communication device 222 performs communication in compliance with, for example, Wi-Fi or BLUETOOTH. Any suitable standard can be applied other than the Wi-Fi and BLUETOOTH. The wireless communication device 222 forms an access point. When a user sets a SSID and a password that the user obtains in advance in the terminal carried by the user, the terminal is connected to the access point.

It is preferable that two access points are provided for the wireless communication device 222 as follows:
(a) Access point to the Internet; and (b) Access point to Intra-company network to the Internet. The access point (a) is for users other than, for example, company staffs. The access point (a) does not allow access from such users to the intra-company network but allow access to the Internet. The access point (b) is for intra-company users and allows such users to access the intra-company network and the Internet.

The infrared I/F 223 detects another display apparatus 2 provided adjacent to the own display apparatus 2. The infrared I/F 223 detects an adjacent display apparatus 2 using the straightness of infrared rays. Preferably, one infrared I/F 223 is provided on each side of the display apparatus 2. This configuration allows the display apparatus 2 to detect a direction in which an adjacent display apparatus 2 is arranged. Such arrangement extends the screen. Accordingly, the user can instruct the adjacent display apparatus 2 to display a previous handwritten object. In other words, one display 220 (screen) corresponds to one page, and the adjacent display 220 displays the handwritten object on a separate page.

The power control circuit 224 controls the AC adapter 225 and the battery 226, which are power supplies of the display apparatus 2. The AC adapter 225 converts alternating current shared by a commercial power supply into direct current.

In a case that the display 220 is a so-called electronic paper, little or no power is consumed to maintain display of an image, and the display apparatus 2 may be driven by the battery 226, accordingly. This allows the display apparatus 2 to be used as, for example, a digital signage that is also usable in a place, such as a place in the open air, where a power source is hardly secured.

The USB interface 229 is an interface to which an external memory such as a USB memory 230 is connected.

The display apparatus 2 further includes a bus line 210. The bus line 210 is, for example, an address bus or a data bus, which electrically connects the components illustrated in FIG. 4, such as the CPU 201.

The touch sensor 216 is not limited to the optical sensing, but may use, for example, a capacitance touch panel that identifies a contact position by detecting a change in capacitance. Further, the touch sensor 216 may use a resistance film touch panel that identifies a contact position by a change in voltage of two opposing resistance films. The touch sensor 216 may be an electromagnetic inductive touch panel that detects electromagnetic induction generated by a touch of an object onto a display to determine the touched position. The touch sensor 216 can be a type that does not use an electronic pen to detect whether the pen tip is in contact with the surface of the display 220 or not. In this case, a fingertip or a pen-shaped stick is used for touch operation. In addition, the pen 2500 may have any suitable shape other than a slim pen shape.

Terminal Device

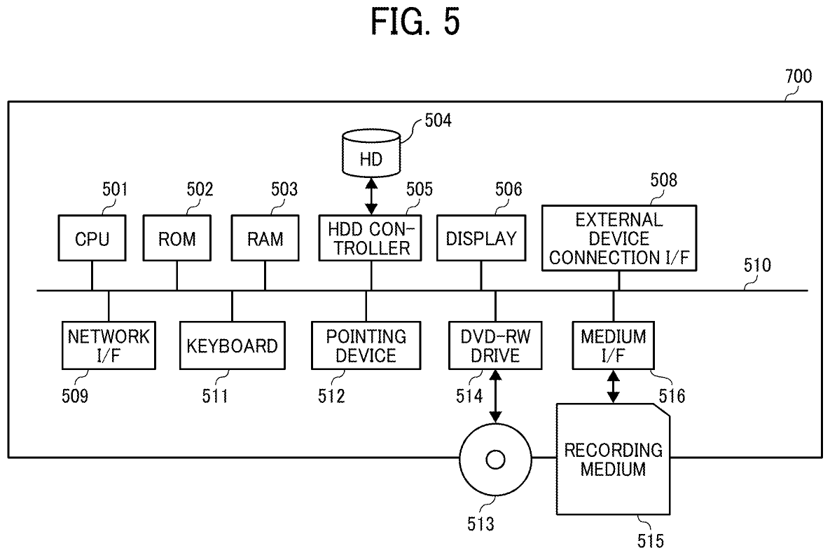

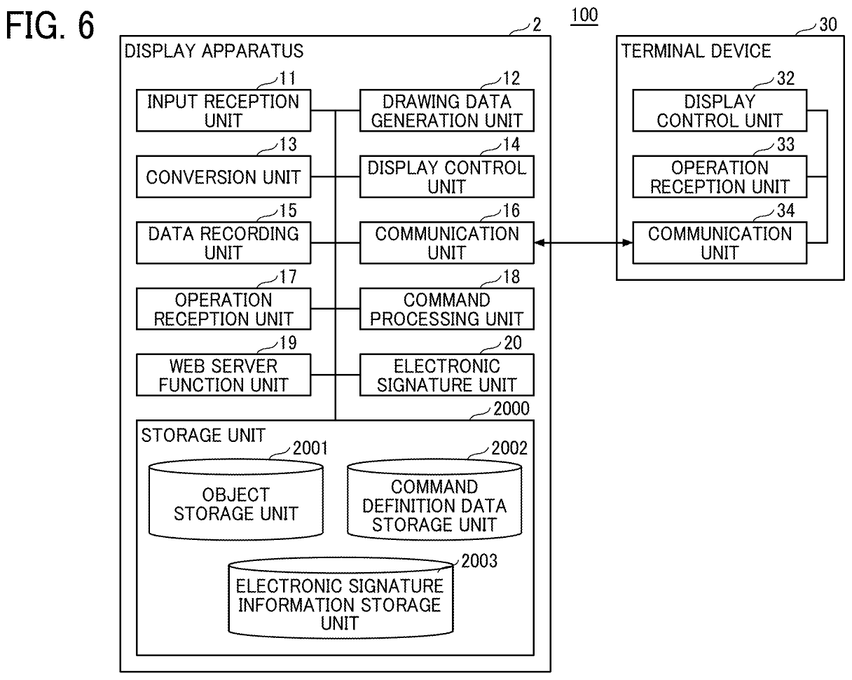

The terminal device 30 is implemented by, for example, a computer having a hardware configuration illustrated in FIG. 5. FIG. 5 is a block diagram illustrating an example hardware configuration of a computer. As illustrated in FIG. 5, a computer 700 includes CPU 501, ROM 502, RAM 503, hard disc (HD) 504, a hard disc drive (HDD) controller 505, a display 506, an external device connection I/F 508, a network I/F 509, a bus line 510, a keyboard 511, a pointing device 512, an optical drive 514, and a medium I/F 516.

The CPU 501 controls the entire operation of the computer 700. The ROM 502 stores programs such as an initial program loader (IPL) to boot the CPU 501. The RAM 503 is used as a work area for the CPU 501. The HD 504 stores various data such as a program. The HDD controller 505 controls reading and writing of various data from and to the HD 504 under control of the CPU 501. The display 506 displays various information such as a cursor, menu, window, character, or image. The external device connection I/F 508 is an interface that for connecting to various external devices. Examples of the external devices include, but not limited to, a USB memory and a printer. The network I/F 509 is an interface for performing data communication using a communication network. The bus line 510 is an address bus or a data bus that electrically connects the elements illustrated in FIG. 5, such as the CPU 501, to each other.

The keyboard 511 is an example of an input device provided with a plurality of keys for allowing a user to input characters, numerals, or various instructions. The pointing device 512 is an example of an input device that allows a user to select or execute various instructions, select an item for processing, or move a cursor being displayed. The optical drive 514 controls reading or writing of various data from or to an optical recording medium 513, which is an example of a removable recording medium. The optical drive 514 includes a compact disc (CD), digital versatile disc (DVD), and BLU-RAY. The medium I/F 516 controls reading and writing (storing) of data from and to a storage medium 515, such as a flash memory.

Functions

A functional configuration of each of the display apparatus 2 and the terminal device according to the present embodiment is described below with reference to FIG. 6. FIG. 6 is a block diagram illustrating an example of functional configurations of the display apparatus 2 and the terminal device 30 according to the present embodiment.

Display Apparatus

The display apparatus 2 includes an input reception unit 11, a drawing data generation unit 12, a conversion unit 13, a display control unit 14, a data recording unit 15, a communication unit 16, an operation reception unit 17, a command processing unit 18, a web server function unit 19, and an electronic signature unit 20. Each of the functional units of the display apparatus 2 is implemented by or is caused to function by operation of one or more of the elements illustrated in FIG. 4 according to an instruction from the CPU 201 according to a program loaded from the SSD 204 to the RAM 203.

The input reception unit 11 receives an input of trajectory of coordinates (coordinate point sequence, hand drafted input data) by detecting coordinates of a position at which an input device such as the pen 2500 contacts the touch sensor 216. The drawing data generation unit 12 acquires coordinates of each position touched by the pen tip of the pen 2500 from the input reception unit 11. The drawing data generation unit 12 connects coordinate points into a coordinate point sequence by interpolation, to generate stroke data.

The conversion unit 13 performs character recognition processing on one or more pieces of stroke data (hand drafted input data), namely the stroke data corresponding to one or more strokes, input by a hand drafted input operation of the user and converts the stroke data into text (character code). The conversion unit 13 recognizes characters (of multilingual languages such as English as well as Japanese), numbers, symbols (e.g., %, $, and &) concurrently with a pen operation by the user. In addition, the conversion unit 13 performs shape recognition processing on one or more pieces of stroke data (hand drafted input data) input by a hand drafted input operation of the user and converts the stroke data into a shape (e.g., line, circle, and triangle). Although various algorithms have been proposed for the recognition method, a detailed description is omitted on the assumption that known techniques can be used in the present embodiment.

The display control unit 14 displays, on the display, for example, hand drafted input data, a character string converted from the hand drafted input data, and an operation menu to be operated by the user.

The data recording unit 15 stores hand drafted input data input to the display apparatus 2, converted text, a screenshot of PC screen, a file, and the like in an object storage unit 2001 (a memory). Each of hand drafted input data, text (including shape), an image such as a PC screen, and a file, is an object. With respect to hand drafted input data, a set of pieces of stroke data is one object. The set of pieces of stroke data is defied by time, for example, due to interruption of hand drafted input. In addition, a set of pieces of stroke data is defied by a position where the hand drafted input is performed.

The communication unit 16 communicates with the terminal device 30 by short-range wireless communication such as Wi-Fi. The communication unit 16 can also communicate by connecting to a wired LAN. In addition, the communication unit 16 can be connected to the Internet by using a communication function with a mobile phone base station included in the terminal device 30 (the terminal device 30 supports a tethering function). The communication unit 16 can share, for example, hand drafted input data, a converted character string, a PC screen, and a file with another display apparatus 2 placed at another site.

The operation reception unit 17 receives a user operation performed on the display apparatus 2, such as selection of an operation menu or selection of a character string candidate.

The command processing unit 18 executes processing related to the operation command. A command processing unit 18 determines whether the text converted by the conversion unit 13 partially matches a recognition character string of an operation command registered to the command definition data or not, and when the text partially matches the recognition character string, a display control unit 24 displays the operation command on an operation guide 500. Partially matching means at least partially matching and includes matching completely. Regarding determining whether to partially match or not, the minimum number of characters to match is set in advance. The command processing unit 18 may determine whether a shape converted by the conversion unit 13 partially matches a recognition shape (preset shape) of an operation command registered to the command definition data or not. The command processing unit 18 is an example of a determination unit.

The web server function unit 19 provides functions of a web server (also referred to as a hypertext markup language (HTML) server or a world wide web (WWW) server) and an application server to the terminal device 30. In other words, the web server function unit 19 interprets a hypertext transfer protocol (HTTP) request transmitted from the terminal device and transmits an HTTP response (web page). Accordingly, the terminal device 30 can display the web page. The web server function unit 19 may execute a web application. While a web page is a static web document, a web application can dynamically change an object in response to a request from a user.

The electronic signature unit 20 generates an electronic signature for the stored data. The electronic signature unit 20 is called by, for example, the command processing unit 18, encrypts a hash value of the stored data with a private key specified by the user by hand drafted input, and combines the encrypted hash value with the stored data.

In addition, the display apparatus 2 includes the storage unit 2000 implemented by, for example, the SSD 204 or the RAM 203 illustrated in FIG. 4. The storage unit 2000 includes the object storage unit 2001, a command definition data storage unit 2002, and an electronic signature information storage unit 2003.

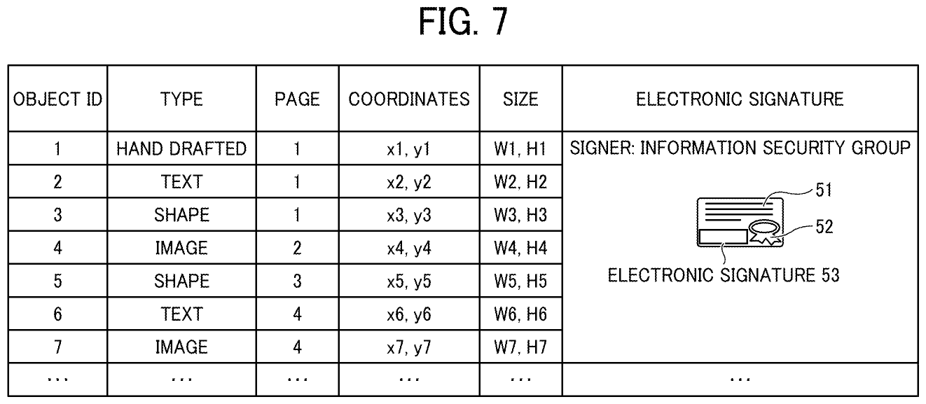

FIG. 7 is a diagram schematically illustrating an example of information on objects stored in the object storage unit 2001. The object is various types of data displayed by the display apparatus 2.

The item of object ID indicates identification information for identifying an object.

The item of type indicates a type of object, and the type of object includes, for example, hand drafted, text, graphic, and image.

“Hand drafted” indicates stroke data (coordinate point sequence). “Text” represents a character string (character code) converted from hand drafted input data. “Shape” indicates a geometric shape, such as a triangle and a quadrangle, each of which is converted from hand drafted input data. “Image” indicates image data in a format such as Joint Photographic Experts Group (JPEG), Portable Network Graphics (PNG), or Tagged Image File Format (TIFF) acquired from, for example, a PC or the Internet.

A single screen of the display apparatus 2 is referred to as a page. The item of page indicates a page number.

The item of coordinates indicates a position of the object with reference to a predetermined origin of the display apparatus 2. The position of the object is, for example, the upper left vertex of a circumscribed rectangle of the object. The coordinates are expressed, for example, in pixels of the display.

The item of size indicates a width and a height of a circumscribed rectangle of the object.

The item of the electronic signature is combined data including an electronic signature and an electronic certificate for storage data (plaintext storage data, electronic signature, and electronic certificate). The stored data may be represented by any unit, but for example, all pages are converted into a PDF file as the stored data. The item of electronic signature includes a signer and combined data (plaintext storage data 51, an electronic signature 53, and an electronic certificate 52) that are registered. The combined data includes, for example, “ABC” (plaintext storage data 51) that input by hand drafted input performed by the user A as illustrated in FIG. 1, data (electronic signature 53) that is obtained by encryption based on a hash value obtained by converting “ABC,” and the electronic certificate 52 issued by the certificate authority. The electronic signature may be generated in units of pages or in units of areas arbitrarily selected by the user.

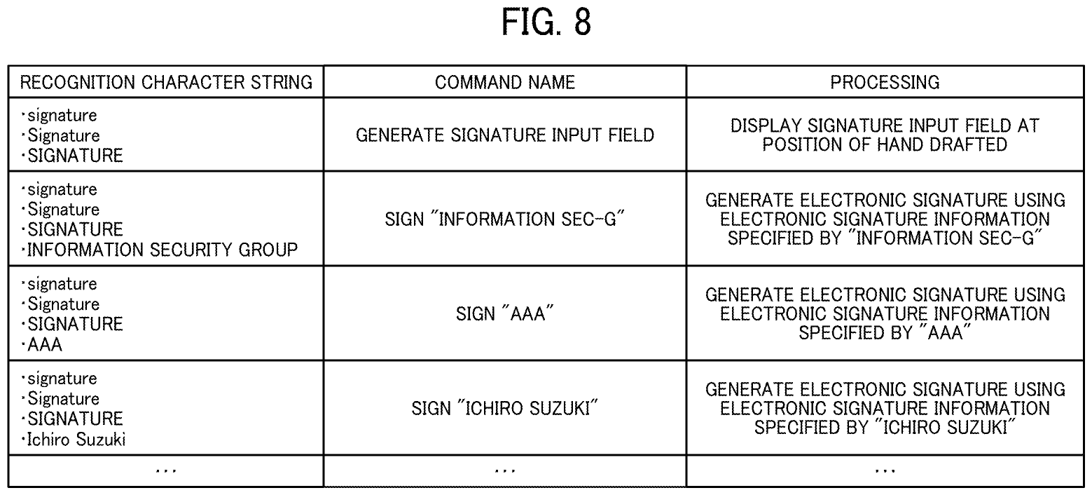

FIG. 8 is a diagram schematically illustrating an example of command definition data stored in the command definition data storage unit 2002. The command definition data defines an operation command in association with the recognition character string. The operation command is used to instruct the display apparatus 2 by the user.

The item of recognition character string indicates a character string to be compared with the text obtained by character recognition performed by the conversion unit 13. For example, when the recognition character string is “signature,” “Signature,” or “SIGNATURE,” the text obtained by character recognition performed by the conversion unit 13 is compared with the recognition character string to determine whether the text partially matches the recognition character string or not.

The item of command name indicates a name of the operation command displayed in the operation guide.

The item of processing indicates details of processing performed by the display apparatus 2 when the operation command is selected by the user.

An operation command related to a command name, “SIGN “INFORMATION SEC-G”” or “SIGN “AAA,”” is added every time the user registers electronic signature information to the display apparatus 2, as described later. With this configuration, the display apparatus 2 can display the command name including the abbreviation of the electronic signature information.

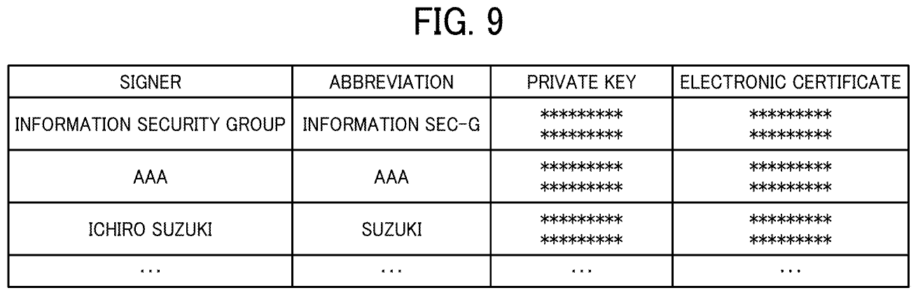

FIG. 9 is a diagram schematically illustrating an example of electronic signature information stored in the electronic signature information storage unit 2003. The electronic signature information is information used by the display apparatus 2 to generate an electronic signature.

The items of signer and abbreviation indicate a name of the user who registered an electronic signature information and an abbreviation of the signer, respectively. The signer and abbreviation can be set by the user, as described later. The abbreviation set in the item of abbreviation may be a part of the command name as described above.

The item of private key indicates a private key registered by the signer.

The item of electronic certificate indicates an electronic certificate issued by the certificate authority. The electronic certificate includes a public key corresponding to the private key.

Terminal Device

Referring again to FIG. 6, the functional configuration of the terminal device 30 is described below. The terminal device 30 includes a display control unit 32, an operation reception unit 33, and a communication unit 34. Each of the functional units of the terminal device 30 is implemented by or is caused to function by operation of one or more of the elements illustrated in FIG. 5 according to an instruction from the CPU 501 executing a program loaded from the HD 504 to the RAM 503. The program may be either a web browser or an application dedicated to the display apparatus 2.

The communication unit 34 communicates with the display apparatus 2 by short-range wireless communication such as Wi-Fi. The terminal device 30 can also communicate with a mobile phone base station, and can be connected to the Internet via a gateway provided by a mobile phone carrier.

The display control unit 32 displays, on the display, a web page or a web application acquired from the web server function unit 19 of the display apparatus 2. The operation reception unit 33 receives an operation performed with respect to the terminal device 30 via a web page or a web application, for example.

Registration of Electronic Signature Information

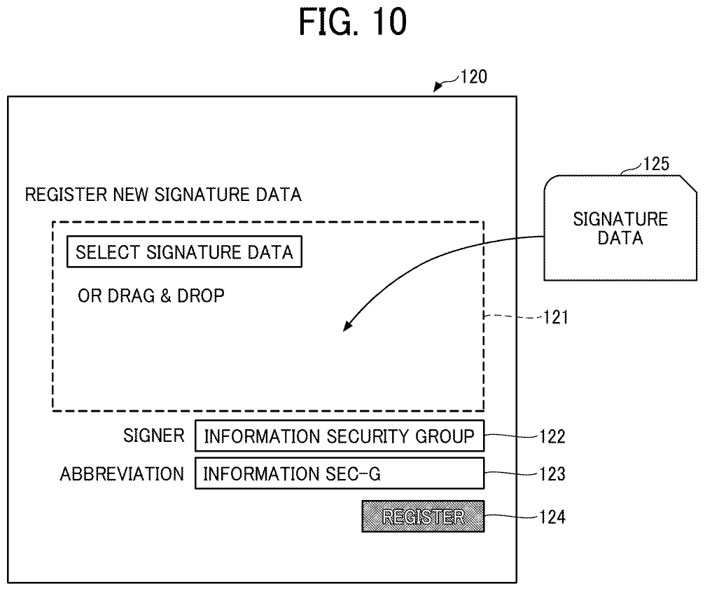

Referring to FIG. 10, an operation of registering electronic signature information is described below.

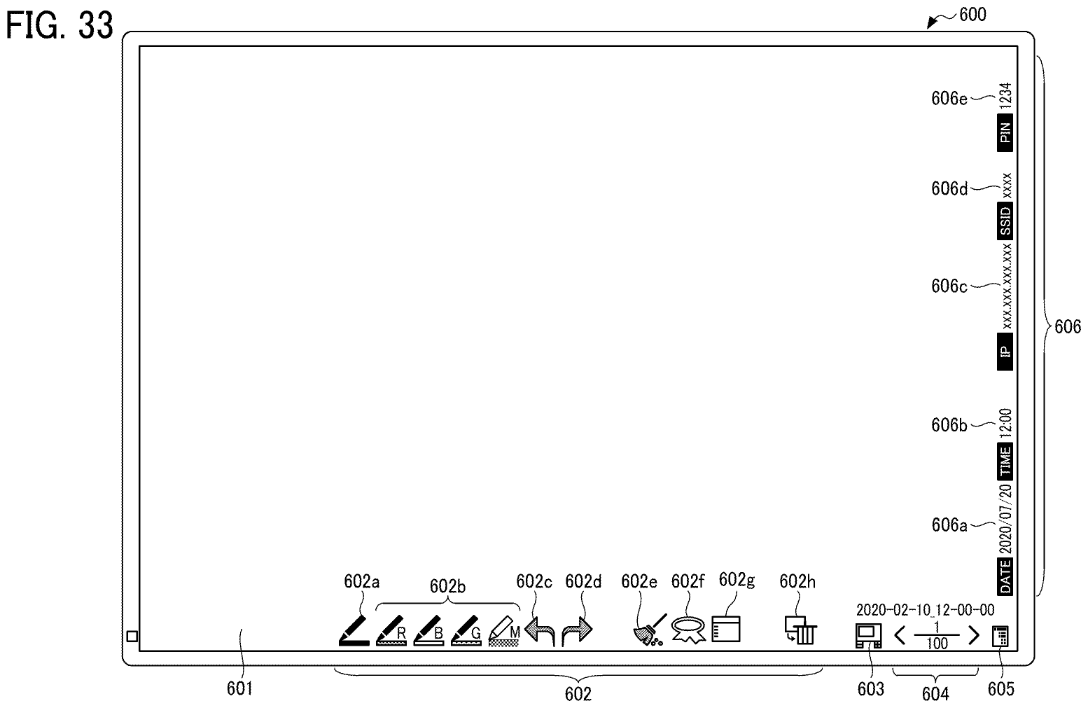

FIG. 10 is a diagram illustrating an example of an electronic signature information registration screen 120 displayed by the terminal device 30. In order to display the electronic signature information registration screen 120, the SSID and the PIN (information for connecting to an access point) to be displayed by the display apparatus 2 are set to the terminal device 30, and further the internet protocol (IP) address of the display apparatus 2 is set, according to a user operation (see FIG. 33).

The terminal device 30 receives authentication for registering electronic signature information from the display apparatus 2. The terminal device 30 receives a user operation of inputting an identification (ID) and a password to be transmitted to the display apparatus 2, and after transmitting the ID and the password, receives screen information of the electronic signature information registration screen 120 from the web server function unit 19 of the display apparatus 2. This processing prevents registering the electronic signature information by a general user, and allows a predetermined administrator to register the electronic signature information.

As illustrated in FIG. 10, the electronic signature information registration screen 120 includes a signature data field 121, a signer field 122, an abbreviation field 123, and a registration button 124.

The signature data field 121 is a field to which the user drags and drops signature data 125 (private key and electronic certificate) or with which the user specifies a file of the signature data. The signature data 125 includes a private key and an electronic certificate.

The signer field 122 is a field with which the user sets a signer. The signer may be identification information used by the user to call up the electronic signature information.

An abbreviation field 123 is a field with which the user sets an abbreviation of the signer. The abbreviation may be a part of the name of the operation command. The abbreviation may be identification information used by the user to call up the electronic signature information.

When the user presses the registration button 124, information input on the electronic signature information registration screen 120 is transmitted to the display apparatus 2. The display apparatus 2 receives the information and stores the information in the electronic signature information storage unit 2003.

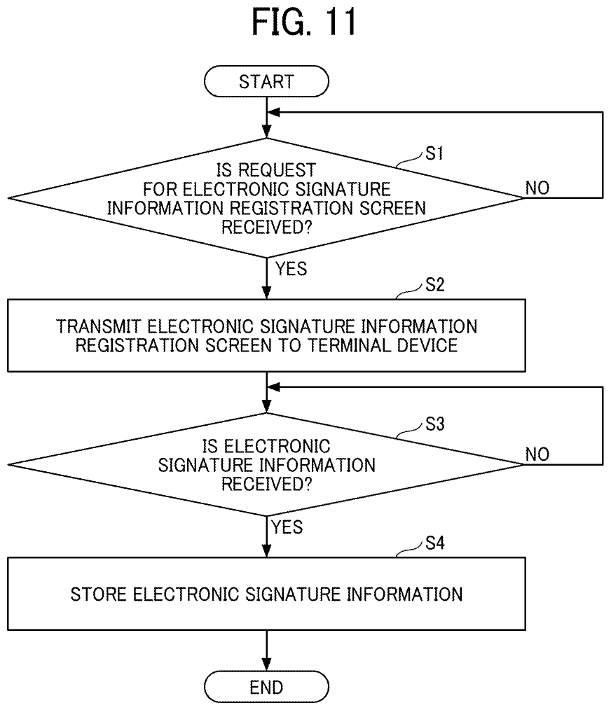

FIG. 11 is a flowchart illustrating an example of a process performed by the display apparatus 2 for receiving registration of the electronic signature information.

First, the web server function unit 19 of the display apparatus 2 determines whether a request for the electronic signature information registration screen 120 is received via the communication unit 16 or not (S1).

When the request for the electronic signature information registration screen 120 is received, the web server function unit 19 transmits screen information of the electronic signature information registration screen 120 to the terminal device 30, which is a request source (S2).

The web server function unit 19 of the display apparatus 2 determines whether the electronic signature information is received via the communication unit 16 or not (S3).

When the electronic signature information is received (Yes in S3), the electronic signature unit 20 stores the received electronic signature information in the electronic signature information storage unit 2003 (S4). In addition, the command processing unit 18 registers a predetermined character string such as “signature” and a signer to a recognition character string, and registers a command name including an abbreviation and details of processing to the command definition data storage unit 2002.

Management and Deletion of Electronic Signature Information

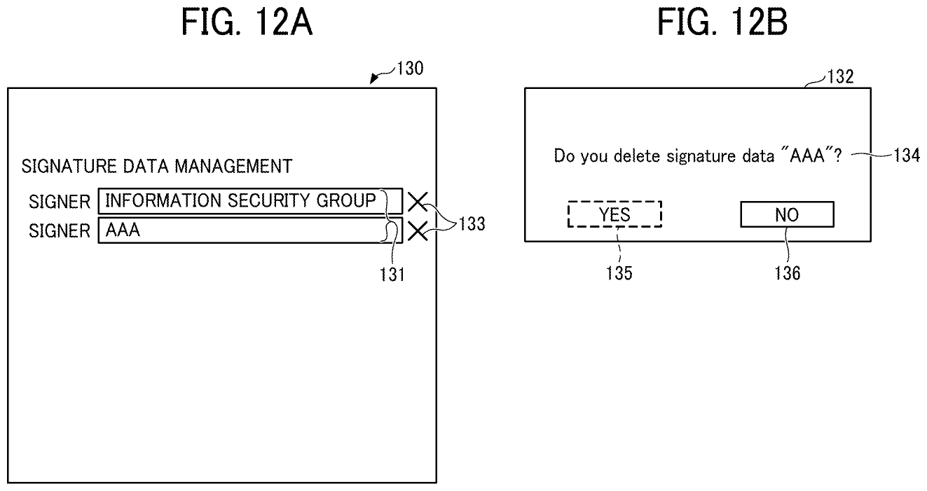

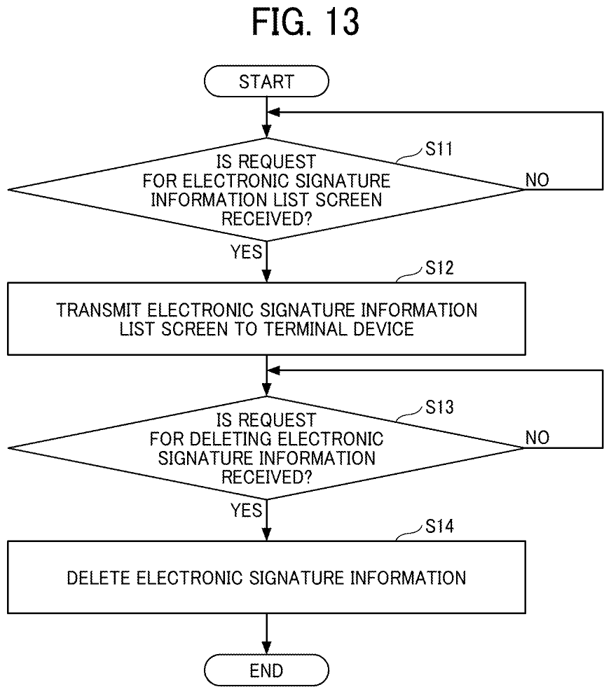

Next, management and deletion of electronic signature information are described with reference to FIGS. 12A, 12B and 13. FIG. 12A is a diagram illustrating an example of an electronic signature information list screen 130 displayed by the terminal device 30. The terminal device 30 communicating with the display apparatus 2 according to a user operation displays the electronic signature information list screen 130.

In substantially the same manner as displaying the electronic signature information registration screen 120, authentication is performed for displaying the electronic signature information list screen 130.

The electronic signature information list screen 130 displays an electronic signature information list 131 that is a list of electronic signature information registered to the display apparatus 2. The electronic signature information list 131 is, for example, the signer displayed in the signer field 122 in FIG. 10, but may include an abbreviation. Editing the signer of the electronic signature information list 131 is disabled for the user.

The electronic signature information list screen 130 has a delete button 133 at the right end of the signer. The user can delete the electronic signature information by pressing or clicking the delete button 133.

FIG. 12B is a diagram illustrating an example of a confirmation message 132 displayed when the delete button 133 is pressed. The confirmation message 132 includes a message 134 “Do you delete signature data “AAA”?,” an YES button 135, and a NO button 136. When the YES button 135 is pressed, the display apparatus 2 deletes the electronic signature information from the electronic signature information storage unit 2003.

FIG. 13 is a flowchart illustrating an example of a process performed by the display apparatus 2 for receiving an operation for deleting the electronic signature information. First, the web server function unit 19 of the display apparatus 2 determines whether a request for an electronic signature information list screen is received via the communication unit 16 or not (S11).

When the request for the electronic signature information list screen is received (Yes in S11), the web server function unit 19 transmits screen information of the electronic signature information list screen 130 to the terminal device 30, which is the request source (S12).

The web server function unit 19 of the display apparatus 2 determines whether the request for deleting the electronic signature information (including the signer) is received via the communication unit 16 or not (S13).

When the request for deleting the electronic signature information is received (Yes in S13), the electronic signature unit 20 deletes the electronic signature information specified by the signer from the electronic signature information storage unit 2003 (S14).

Electronic Signature Processing

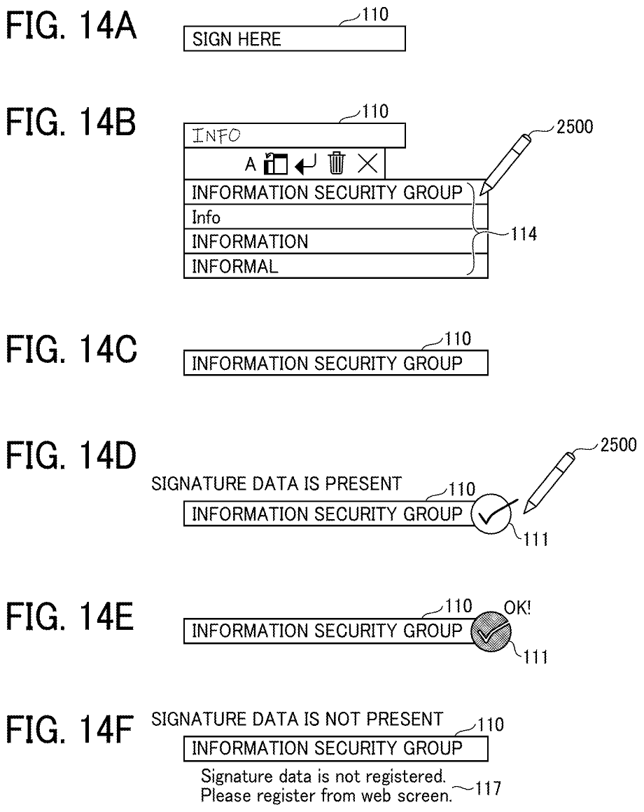

Referring to FIGS. 14 (FIGS. 14A to 14F) to 16, a process in which a user requests for an electronic signature from the display apparatus 2 and the display apparatus 2 generates the electronic signature is described. There are a case that the signature input field 110 is displayed in the initial state of the display apparatus 2 and a case that the signature input field 110 is caused to be displayed according to a user operation. First, the case that the display apparatus 2 displays the signature input field 110 in the initial state is described. The case that the display apparatus 2 displays the signature input field 110 in the initial state is a case that the signature input field 110 is prepared in, for example, PDF data to be displayed by the display apparatus 2.

FIGS. 14A to 14F are diagrams illustrating transition of information displayed in relation to the signature input field 110. Note that the description of FIGS. 14A to 14F partially overlaps with that of FIGS. 2A to 2F.

FIG. 14A illustrates the signature input field 110 displayed in the initial state. In the signature input field 110, the placeholder text of “SIGN HERE” is displayed. When the signature input field 110 is displayed, the electronic signature unit 20 obtains information on the signature input field 110 being displayed and a position of the signature input field 110.

As illustrated in FIG. 14B, the user performed hand drafted input to call up his or her electronic signature information. In a case that the user is a member of the information security group, the user may perform hand drafted input to input “INFO,” for example. The display apparatus 2 displays several character string candidates 114 on the operation guide 500 by performing character recognition on “INFO.” The character string candidate 114 is a text obtained by converting “INFO,” and includes a character string predictively converted from the text. In a case of Japanese, a Chinese character may be included in the character string candidate predictively converted from Hiragana input by hand drafted input. In FIG. 14B, a character string candidate “INFORMATION SECURITY GROUP” predictively converted from the text “INFO” is displayed.

Although the operation guide 500 is displayed in FIG. 14B, since the hand drafted input is performed to the signature input field 110, the hand drafted input data is used for electronic signature in many cases. For this reason, when the name of the signer or the name of the group to which the signer belongs is included in the character string candidates 114, the display control unit 14 may display the name as illustrated in FIG. 14C without displaying the operation guide 500.

When the user selects “INFORMATION SECURITY GROUP” in the operation guide 500 with the pen 2500 as illustrated in FIG. 14B, “INFORMATION SECURITY GROUP” is displayed in the signature input field 110 as illustrated in FIG. 14C. When text is newly displayed, the electronic signature unit 20 determines whether a circumscribed rectangle of the text and the signature input field 110 overlap at a ratio equal to or greater than a threshold or not. When this condition is satisfied, the electronic signature unit 20 searches the electronic signature information storage unit 2003 for the text (INFORMATION SECURITY GROUP), because the text is input to the signature input field 110.

As illustrated in FIG. 14D, when the text input to the signature input field 110 matches the signer of the electronic signature information storage unit 2003, the display control unit 14 displays the check mark 111 in relation to the signature input field 110. As described above, the check mark 111 is an indication that the electronic signature is available.

As illustrated in FIG. 14E, when the user touches the check mark 111 with the pen, the display control unit 14 inverts the check mark 111. In addition, the electronic signature unit 20 generates an electronic signature using electronic signature information associated with the text (“INFORMATION SECURITY GROUP”) input to the signature input field 110.

The text input to the signature input field 110 and the check mark 111 may be kept being displayed. Keeping the text and the check mark 111 being displayed indicates the fact that the signature has been made and who has signed the signature.

As described above, the user can generate an electronic signature by hand drafted input performed to the signature input field 110. When the user selects the character string candidate 114, the text may be entered in the signature input field 110. Accordingly, there is no need for the user to switch between inputting text and generating electronic signature.

As illustrated in FIG. 14F, when the text input to the signature input field 110 does not match the signer of the electronic signature information storage unit 2003, the display control unit 14 displays “Signature data is not registered. Please register from web screen.” as a message 117. The user who views the message 117 can register the electronic signature information as described with reference to FIG. 10.

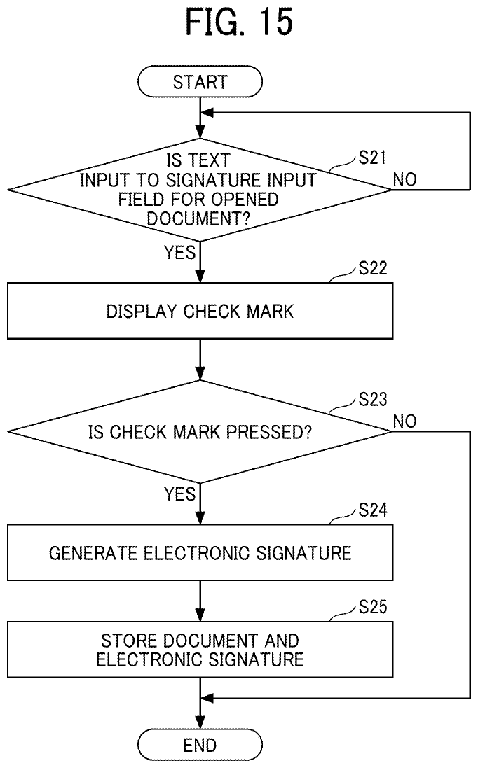

FIG. 15 is a flowchart illustrating an example of a process performed by the display apparatus 2 for generating an electronic signature in response to hand drafted input performed to the signature input field 110. The process of FIG. 15 starts when the display apparatus 2 displays prepared PDF data, for example.

The electronic signature unit 20 determines whether the text of the signer is input to the signature input field 110 or not (S21). As described above, the electronic signature unit determines whether a circumscribed rectangle of the text and the signature input field 110 overlap at a ratio equal to or greater than a threshold or not. When this condition is satisfied, the electronic signature unit 20 searches the electronic signature information storage unit 2003 for the text input to the signature input field 110 by the signer.

When the signer registered to the electronic signature information storage unit 2003 is input to the signature input field 110 (Yes in S21), the display control unit 14 displays the check mark 111 in relation to the signature input field 110 (S22).

The operation reception unit 17 determines whether a user operation of pressing the check mark 111 is received or not (S23).

When the operation reception unit 17 receives the user operation of pressing the check mark 111 (Yes in S23), the display control unit 14 inverts the check mark 111. In addition, the electronic signature unit 20 generates an electronic signature using electronic signature information associated with the text input to the signature input field 110 (S24).

The electronic signature unit 20 stores the stored data, the electronic signature, and the electronic certificate (collectively referred to as a document in the drawings) in the object storage unit 2001 (S25).

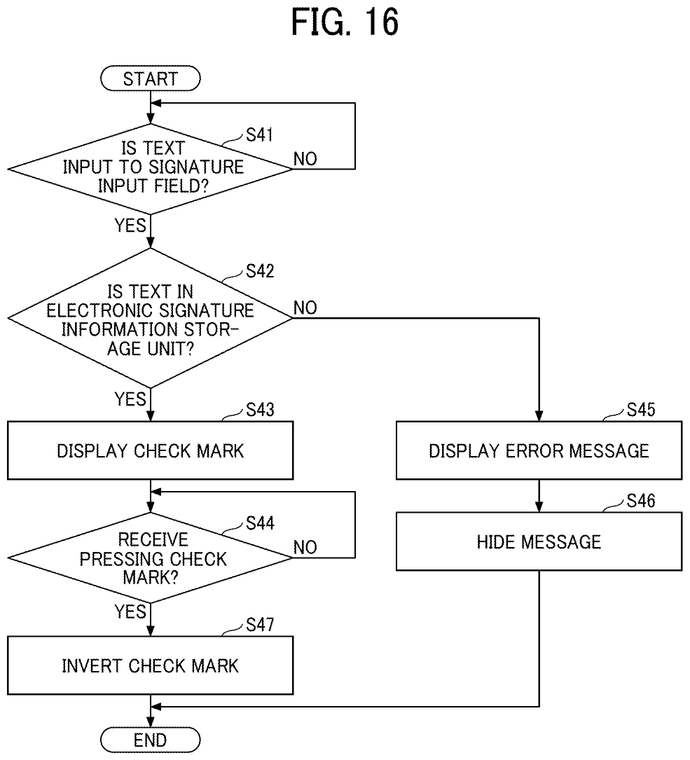

FIG. 16 is a flowchart illustrating an example of a process performed by the electronic signature unit 20 for determining whether the text of the signer is input to the signature input field 110 or not.

The electronic signature unit 20 determines whether the text is input to the signature input field 110 or not (S41).

Specifically, the electronic signature unit 20 determines whether a circumscribed rectangle of the text displayed by being selected from the operation guide 500 and the signature input field 110 overlap at a ratio equal to or greater than a threshold or not. The electronic signature unit 20 may determine the overlap between the circumscribed rectangle of the hand drafted input data input by hand drafted input by the user and the signature input field 110.

When the determination result in step S41 is Yes, the electronic signature unit 20 searches the electronic signature information storage unit 2003 for the text input to the signature input field 110 by the signer (S42).

When the text input to the signature input field 110 matches the signer of the electronic signature information storage unit 2003 (Yes in S42), the electronic signature unit displays the check mark 111 in relation to the signature input field 110 (S43).

In addition, the operation reception unit 17 determines whether a user operation of pressing the check mark 111 is received or not (S44). When the operation reception unit 17 receives the user operation of pressing the check mark 111 (Yes in S44), the display control unit 14 inverts the check mark 111 (S47).

When the determination result in step S42 is No, the display control unit 14 displays the message 117 indicating an error in proximity to the signature input field 110 (S45). The error message indicates that generating the electronic signature is failed.

In addition, the display control unit 14 hides the message 117 when a predetermined time has elapsed from the start of display of the message 117 (S46).

Displaying Signature Input Field

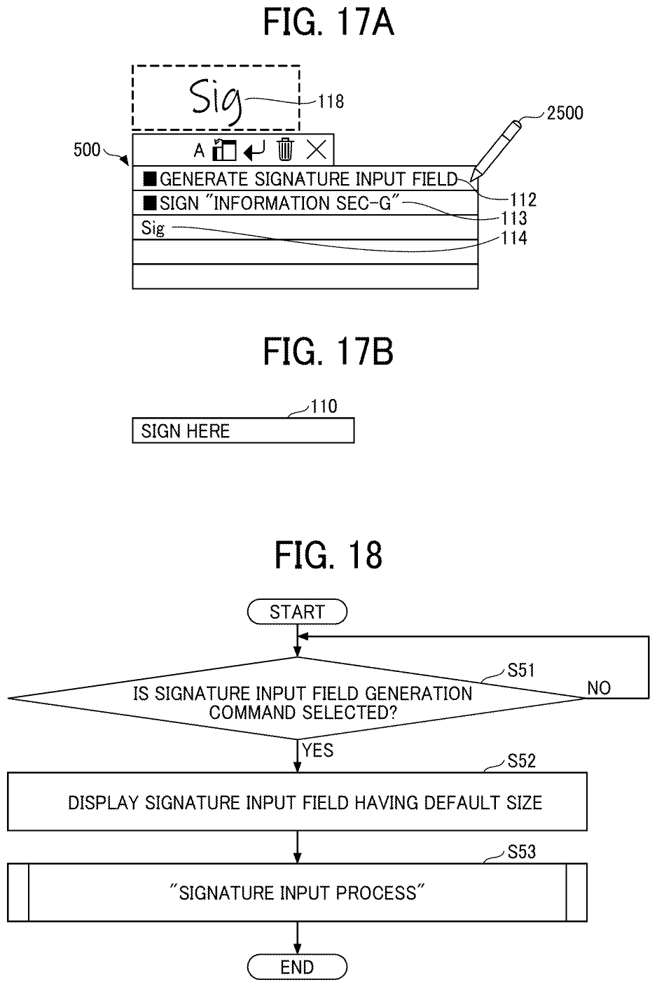

Referring to FIGS. 17A, 17B, and 18, a process for displaying the signature input field 110 is described. When the display apparatus 2 does not currently display the signature input field 110 but the user desires to generate an electronic signature, the signature input field 110 can be caused to be displayed.

FIG. 17A is a diagram illustrating an example of the operation guide 500 including an operation command for displaying the signature input field 110. As illustrated in FIG. 17A, in order to display the signature input field 110, the user who desires to generate an electronic signature inputs hand drafted input data 118 for displaying the signature input field generation command 112. In FIG. 17A, a character string “Sig” that is input by hand drafted input partially matches the recognition character string (for example, “Signature” or “signature”) associated with the signature input field generation command 112 and the signature execution command 113 in the command definition data. The display control unit 14 displays the signature input field generation command 112 of “GENERATE SIGNATURE INPUT FIELD” and a signature execution command 113 of “SIGN INFORMATION SEC-G” in the operation guide 500.

When the user selects the signature input field generation command 112 with the pen 2500, the display control unit 14 displays the signature input field 110. FIG. 17B illustrates the displayed signature input field 110 that is newly displayed. In the signature input field 110, the placeholder text of “SIGN HERE” is displayed. The processing after the signature input field 110 is displayed may be substantially the same as that illustrated in FIGS. 14 (FIG. 14A to 14F) and 15.

The signature input field 110 does not need to be surrounded by a frame line as long as an area to be signed is clearly displayed. For example, the signature input field 110 may be indicated by an underline, by a space between two ruled lines, or color coding, for example.

FIG. 18 is a flowchart illustrating an example of a process performed by the display apparatus 2 for newly displaying the signature input field 110. The process illustrated in FIG. 18 is executable after the start-up of the display apparatus 2.

First, the electronic signature unit 20 determines whether the signature input field generation command 112 is selected or not (S51). In other words, the electronic signature unit 20 determines whether the hand drafted input data has been converted into the text that partially matches the recognition character string associated with the signature input field generation command 112 in the command definition data or not. When the hand drafted input data is converted into the text that partially matches the recognition character string associated with the signature input field generation command 112, the display control unit 14 displays the command name (“GENERATE SIGNATURE INPUT FIELD”), which is associated with the recognition character string, on the operation guide 500.

When the signature input field generation command 112 of “GENERATE SIGNATURE INPUT FIELD” is selected, the display control unit 14 displays the signature input field 110 with a default size, which is a size initially set, after deleting, or hiding, the text converted from the hand drafted input data (S52).

The processing after the signature input field 110 is displayed may be substantially the same as the flowchart illustrated in FIG. 15 (S53).

As described above, since the signature input field 110 can be displayed according to a user operation, the user can generate an electronic signature for the stored data.

Generating Electronic Signature Without Using Signature Input Field

The user can also generate an electronic signature without using the signature input field 110. Without using the signature input field 110 may be either a case that the signature input field 110 is not displayed at all or a case that the signature input field 110 is displayed but the user does not perform hand drafted input to the signature input field 110. The user performs hand drafted input to an area other than the signature input field (other than an input field).

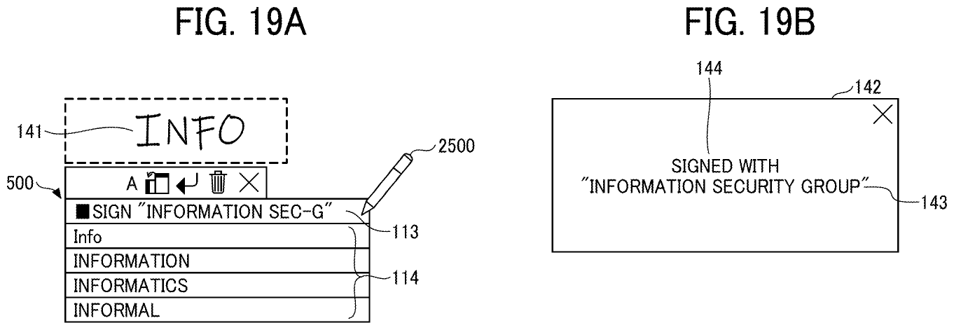

FIGS. 19A and 19B are diagrams illustrating an operation command for generating an electronic signature to be displayed by the display apparatus 2 without using the signature input field 110.

As illustrated in FIG. 19A, in order to cause the display apparatus 2 to generate an electronic signature, the user inputs hand drafted input data 141 of “INFO” by hand drafted input. “INFO” is converted into text by the conversion unit 13. The electronic signature unit determines whether the text partially matches the recognition character string in the command definition data. The recognition character strings of the command definition data include “INFORMATION SECURITY GROUP” that partially match “INFO.” Accordingly, the display control unit 14 causes the operation guide 500 to display the signature execution command 113 of “SIGN “INFORMATION SEC-G.””

The display control unit 14 also causes the operation guide 500 to display the character string candidates 114 that are predictively converted from the text converted from “INFO.”

When the user selects the signature execution command 113 in the operation guide 500 with the pen 2500, the electronic signature unit 20 generates an electronic signature with electronic signature information in which the recognition character string (INFORMATION SECURITY GROUP) of the signature execution command 113 is the signer in the electronic signature information storage unit 2003.

FIG. 19B illustrates a message display field 142 including a message indicating that an electronic signature has been generated. In the message display field 142, a signer 143 of the electronic signature information used to generate the electronic signature and a message 144 indicating that the electronic signature has been generated are displayed.

When the user selects the character string candidate 114 in the operation guide 500 with the pen 2500, text corresponding to the selection can be displayed.

As described above, the user can simply use the text converted from the hand drafted input data for input, and can also select the signature execution command 113 to generate an electronic signature, so that the user does not need to switch between modes for inputting of text and for generating an electronic signature. In the example of FIG. 19A, the hand drafted input data 141, “INFO,” is input according to a user operation of hand drafted input, but hand drafted input is not limited to inputting text and may be inputting a shape such as a circle or a square. The command processing unit 18, which is an example of a determination unit, determines whether text or a shape into which the hand drafted content (hand drafted input data) has been converted is a recognition character string or a recognition shape set in advance. When the command processing unit 18 determines that the converted text or the converted shape is a recognition character string or a recognition shape, which is set in advance, the display control unit 14 displays an operation command or an electronic signature command that is an example of a display command for receiving a user operation for generating an electronic signature, based on the recognition character string or the recognition shape, which is set in advance. When the electronic signature unit 20 receives selection of the operation command or the electronic signature command, which is an example of a display component, the electronic signature unit 20 generates the electronic signature.

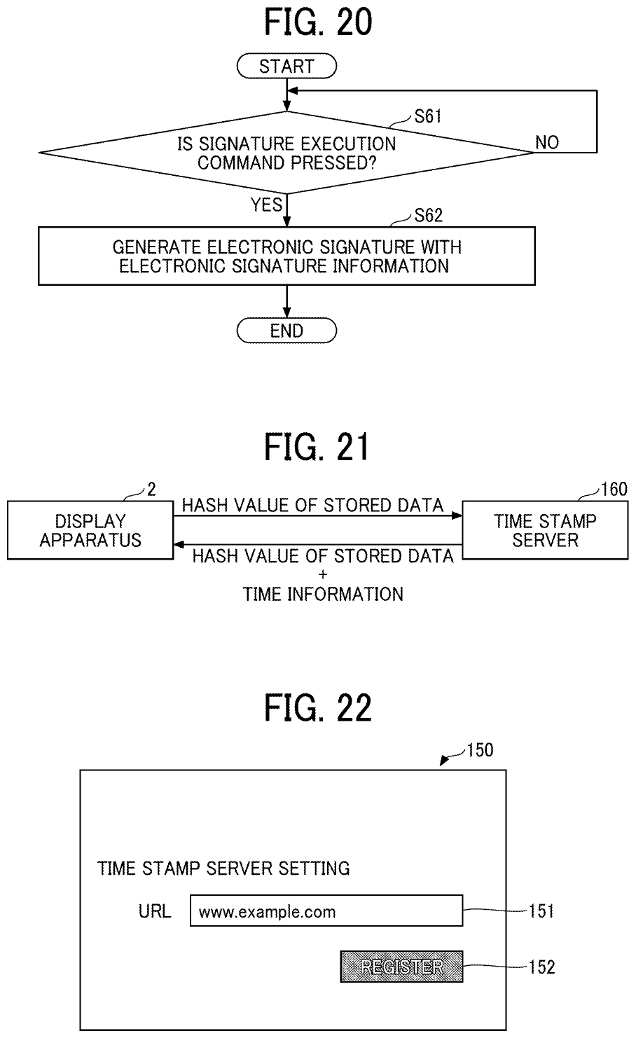

FIG. 20 is a flowchart illustrating an example of a process performed by the display apparatus 2 for generating an electronic signature without using the signature input field 110.

The electronic signature unit 20 determines whether selection of the signature execution command 113 is received or not (S61). In other words, the electronic signature unit 20 determines whether the text input to an area other than the signature input field 110 partially matches the signer in the recognition character string associated with the signature execution command 113. When this condition is satisfied, the display control unit 14 causes the operation guide 500 to display the signature execution command 113, and determines whether the operation reception unit 17 receives selection of the signature execution command 113 or not. As illustrated in FIG. 19A, the signature execution command 113 includes the signer.

When the signature execution command 113 is selected (Yes in S61), the electronic signature unit 20 generates an electronic signature using the electronic signature information associated with the signer included in the signature execution command 113 (S62).

According to the display apparatus 2 of the present embodiment, generating the signature input field 110 and inputting a signature are executable by inputting using a pen. Since the user can use the text converted from the hand drafted input data simply for input or can select the signature execution command 113 to generate an electronic signature, the user does not need to switch between a mode for input of text and a mode for generation of an electronic signature. Executing the command allows the user to generate an electronic signature easily without decreasing work efficiency.

### Second Embodiment

In the following description of a second embodiment, the display apparatus 2 adds time stamp information to the stored data in addition to an electronic signature. The time stamp information is obtained by adding time information to a hash value of the stored data by a time certificate authority.

The present embodiment will be described on the assumption that the hardware configurations illustrated in FIGS. 4 and 5 and the functional configuration illustrated in FIG. 6 described in the first embodiment are applicable.

FIG. 21 is a block diagram illustrating an example of a system configuration when the display apparatus 2 uses a time stamp server 160. The display apparatus 2 requests the time stamp server 160 for time stamp information and transmits the hash value of the stored data. The display apparatus 2 attaches the time information to the hash value and transmits the hash value to the display apparatus 2.

Registration of Uniform Resource Locator (URL) of Time Stamp Server

FIG. 22 is a diagram illustrating an example of a URL setting screen 150 displayed by the terminal device 30 when the user sets the URL of the time stamp server 160 to the display apparatus 2. The terminal device 30 connects to the display apparatus 2 and requests for the URL setting screen 150. The web server function unit 19 of the display apparatus 2 transmits screen information of the URL setting screen 150 to the terminal device 30.

The URL setting screen 150 includes a URL input field 151 and a registration button 152. The user sets the URL of the time stamp server 160 known in advance in the URL input field 151, and presses the registration button 152. Since the terminal device 30 transmits the URL to the display apparatus 2, the electronic signature unit 20 stores the URL in the storage unit 2000.

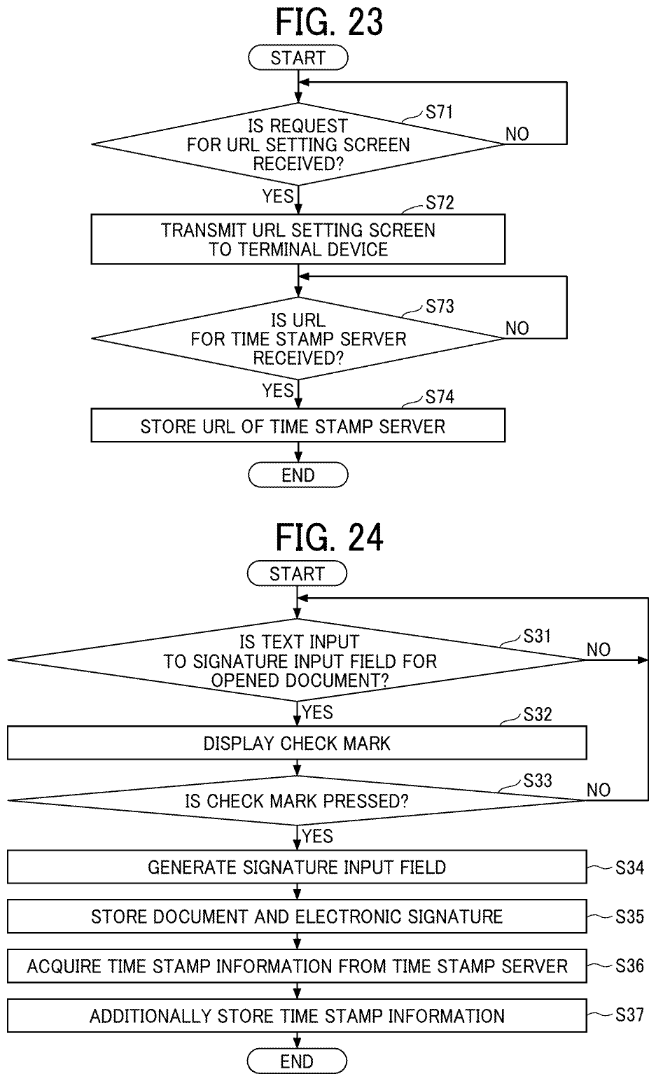

FIG. 23 is a flowchart illustrating an example of a process performed by the display apparatus 2 for receiving settings for the URL of the time stamp server 160.

First, the web server function unit 19 of the display apparatus 2 determines whether a request for the URL setting screen 150 is received via the communication unit 16 or not (S71).

When the request for the URL setting screen 150 is received (Yes in S71), the web server function unit 19 transmits the screen information of the URL setting screen 150 to the terminal device 30, which is the request source (S72).

The web server function unit 19 of the display apparatus 2 determines whether the URL of the time stamp server 160 is received via the communication unit 16 or not (S73).

When the URL of the time stamp server 160 is received (Yes in S73), the electronic signature unit 20 stores the received URL of the time stamp server 160 in the storage unit 2000 (S74).

Electronic Signature Processing

FIG. 24 is a flowchart illustrating an example of a process performed by the display apparatus 2 for generating an electronic signature of which the processing includes adding a time stamp. The following description with reference to FIG. 24 is given with a state in which the signature input field 110 is displayed. However, the signature input field 110 is not necessary.

The electronic signature unit 20 determines whether the signer is input in text in the signature input field 110 (S31) or not. As described above, the electronic signature unit 20 determines whether a circumscribed rectangle of the text and the signature input field 110 overlap at a ratio equal to or greater than a threshold or not. When this condition is satisfied, the electronic signature unit 20 searches the electronic signature information storage unit 2003 for the text input to the signature input field 110.

When the signer is input in text (Yes in S31), the display control unit 14 displays the check mark 111 in relation to the signature input field 110 (S32).

The operation reception unit 17 determines whether a user operation of pressing the check mark 111 is received or not (S33).

When the operation reception unit 17 receives the user operation of pressing the check mark 111 (Yes in S33), the display control unit 14 inverts the check mark 111. In addition, the electronic signature unit 20 generates an electronic signature using electronic signature information associated with the text input to the signature input field 110 (S34), and stores the electronic signature in the object storage unit 2001 (S35).

The electronic signature unit 20 acquires the time stamp information from the time stamp server 160 via the communication unit 16 (S36).

The electronic signature unit 20 adds the time stamp information in association with the electronic signature of step S35, and stores the time information in the object storage unit 2001 (S37).

According to the present embodiment, the display apparatus 2 can add the time stamp information to the electronic signature to be stored, in addition to the effect of the first embodiment.

### Third Embodiment

In the following description of a third embodiment, an electronic signature system 170 in which an electronic signature server 171 on a network generates an electronic signature.

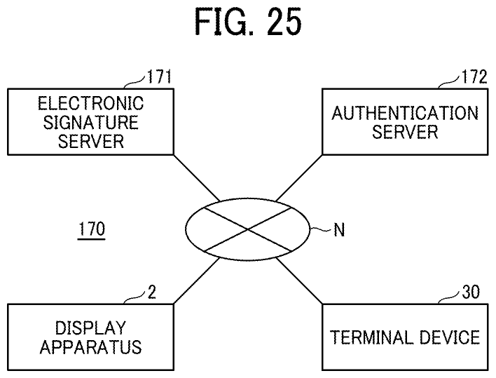

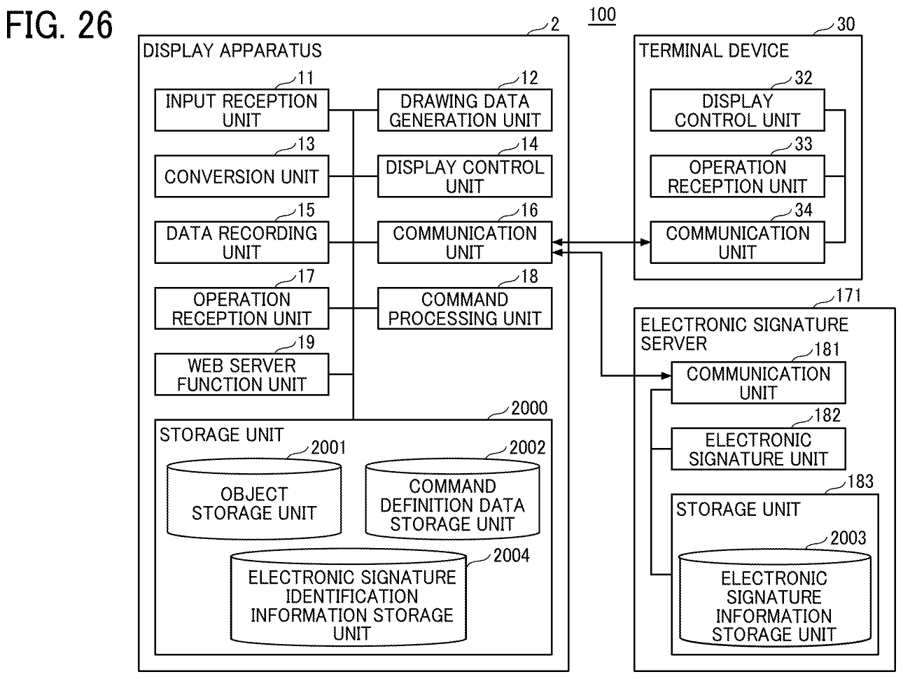

FIG. 25 is a block diagram illustrating an example of a system configuration of the electronic signature system 170. The electronic signature system 170 includes the electronic signature server 171, an authentication server 172, and the display apparatus 2. The terminal device 30 can communicate with the electronic signature server 171, the authentication server 172, and the display apparatus 2 via a network N in a wireless or wired manner.

The electronic signature server 171 is one or more information processing apparatuses. In response to receiving a request for a hash value of the stored data from the display apparatus 2, the electronic signature server 171 generates an electronic signature and responds to the display apparatus 2 with the electronic signature. In substantially the same manner as the first embodiment, the electronic signature information is registered to the electronic signature server 171 from the terminal device 30 in advance. Although a commercial service such as box.com/sign is known as the electronic signature server 171, any service may be used as the electronic signature server 171.

The authentication server 172 is one or more information processing apparatuses. The authentication server 172 authenticates a user, and the authenticated user can use the electronic signature server 171. The user connects the terminal device 30 to the authentication server 172 and registers a user ID and a password, for example. In a case that the display apparatus 2 uses the electronic signature server 171, when authentication by the authentication server 172 is successful, the electronic signature server 171 can be used. The user registered to the authentication server 172 can also register the display apparatus 2 that is the user of the electronic signature server 171. When the display apparatus 2 is registered, the display apparatus 2 can use the electronic signature server 171 regardless of a user who is currently using the display apparatus 2.

The authentication server 172 and the electronic signature server 171 may be integrated. All or a part of the functions of the authentication server 172 and the electronic signature server 171 may reside in a cloud environment or in an on-premises environment.

The terminal device 30 and the display apparatus 2 may be substantially the same as those in the first embodiment. However, the display apparatus 2 according to the present embodiment may not have a function of generating an electronic signature.

Functions

FIG. 26 is a block diagram illustrating an example of functional configurations of the display apparatus 2, the electronic signature server 171, and the terminal device 30 according to the present embodiment. In the following description of FIG. 26, differences from FIG. 6 are mainly described. The authentication server 172 have a known authentication function and the function is not described, accordingly.

Display Apparatus

In comparison with the display apparatus 2 in FIG. 6, the display apparatus 2 does not include the electronic signature unit 20 and the electronic signature information storage unit 2003. This is because the electronic signature server 171 has the corresponding functions. The display apparatus 2 includes an electronic signature identification information storage unit 2004 instead of the electronic signature information storage unit 2003. The other functions may be substantially the same as those in FIG. 6.

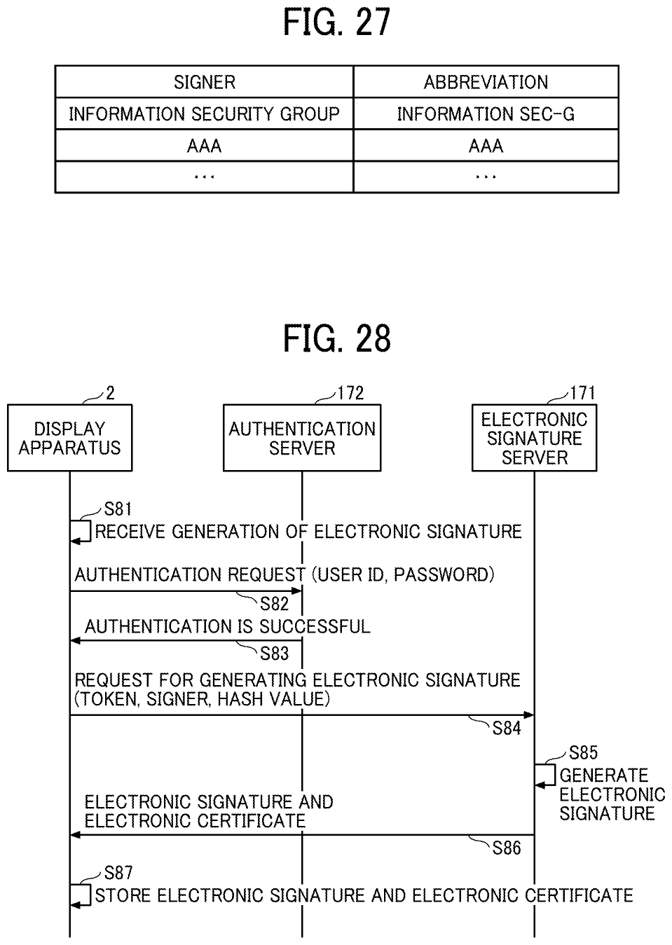

FIG. 27 is a diagram schematically illustrating an example of electronic signature identification information stored in the electronic signature identification information storage unit 2004. The electronic signature identification information includes information on a signer and an abbreviation that serves as identification information from the electronic signature information. At least a part of the electronic signature identification information is used when the display apparatus 2 specifies the electronic signature information with respect to the electronic signature server 171.

In addition, since the display apparatus 2 synchronizes the electronic signature identification information with the electronic signature server 171, the display apparatus 2 obtains the electronic signature identification information from the electronic signature server 171 periodically, at a predetermined timing, such as once a day.

Electronic Signature Server

The electronic signature server 171 includes a communication unit 181 and an electronic signature unit 182. Each of the functional units of the electronic signature server 171 is implemented by or is caused to function by operation of one or more of the elements illustrated in FIG. 5 according to an instruction from the CPU 501 executing a program loaded from the HD 504 to the RAM 503.

The communication unit 181 receives, from the display apparatus 2, a request to generate an electronic signature by specifying electronic signature information and a hash value of the stored data. The communication unit 181 further transmits the generated electronic signature to the display apparatus 2.

The electronic signature unit 20 generates an electronic signature for the hash value of the stored data using the electronic signature information specified by the display apparatus 2.

The electronic signature server 171 has a storage unit 183 implemented by, for example, the HD 504 or the RAM 503 illustrated in FIG. 5, and the electronic signature information storage unit 2003 is implemented by the storage unit 183. The configuration of the electronic signature information storage unit 2003 may be substantially the same as that of FIG. 9 of the first embodiment.

Generating Electronic Signature

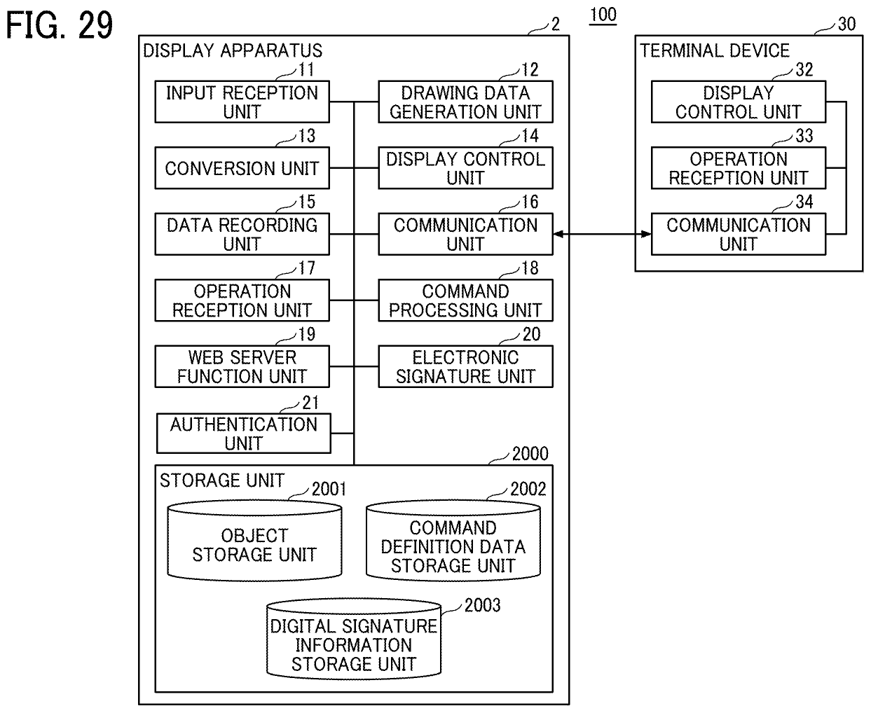

Referring to FIG. 28, a process for generating an electronic signature by the electronic signature system 170 is described. FIG. 28 is a sequence diagram illustrating an example of a process performed by the electronic signature system 170 for generating an electronic signature in response to a request from the display apparatus 2, according to the present embodiment.

S81: The operation reception unit 17 of the display apparatus 2 receives a user operation for generating an electronic signature. In other words, the text input to the signature input field 110 matches the signer of the electronic signature identification information storage unit 2004, or the signature execution command 113 displayed by the text input to an area other than the signature input field 110 is selected. Accordingly, the signer is identified.

S82: The communication unit 16 of the display apparatus 2 specifies a user ID and a password and transmits an authentication request (request for authentication) to the authentication server 172 for authentication. The user ID and the password may be input when the user logs in to the display apparatus 2 or may be set to the display apparatus 2.

S83: The authentication server 172 receives the authentication request and authenticates the user based on the user ID and the password. The following description of the present embodiment is given on the assumption that the authentication is successful. The authentication server 172 transmits a token indicating the authentication is successful to the display apparatus 2. The token includes an authority for the user to use the electronic signature server 171.

S84: When the communication unit 16 of the display apparatus 2 receives the token, the communication unit 16 transmits a request for generating an electronic signature to the electronic signature server 171 by specifying the token, the signer, and the hash value of the stored data.

S85: The communication unit 181 of the electronic signature server 171 receives the request for generating an electronic signature and determines that the authentication of the user is successful based on the token. The electronic signature unit 182 generates an electronic signature by encrypting the hash value transmitted from the display apparatus 2 using electronic signature information associated with the signer.

S86: The communication unit 181 of the electronic signature server 171 transmits the electronic signature and an electronic certificate associated with the signer to the display apparatus 2.

S87: When the communication unit 16 of the display apparatus 2 receives the electronic signature and the electronic certificate, the data recording unit 15 combines the electronic signature with the stored data and stores the combined data along with the electronic certificate in the object storage unit 2001. Time stamp information may be further added.

According to the present embodiment, in addition to the effects of the first and second embodiments, the display apparatus 2 can generate an electronic signature by requesting to the electronic signature server 171. Accordingly, each display apparatus 2 does not need to have the electronic signature information or the electronic signature unit 20.

### Fourth Embodiment

In the following description of a fourth embodiment, the display apparatus 2 to which a user logs in determines whether the user can use the electronic certification information or not. In the first embodiment, the user who inputs a signer by hand drafted input can generate an electronic signature. In the present embodiment, the user who can generate an electronic signature can be restricted. With this configuration, a user who uses the electronic signature information of another user to generate an electronic signature can be prevented.

Functions

FIG. 29 is a block diagram illustrating an example of functional configurations of the display apparatus 2 and the terminal device 30 according to the present embodiment. In the following description of FIG. 29, differences from FIG. 6 are mainly described.

Display Apparatus

The display apparatus 2 further includes an authentication unit 21. The authentication unit 21 authenticates a user based on a user ID and a password that are set in advance or a signature of the user. The user who has been successfully authenticated can log in to the display apparatus 2. The user authentication function may be provided in the display apparatus 2 or on a network.

Registration of Electronic Signature Information

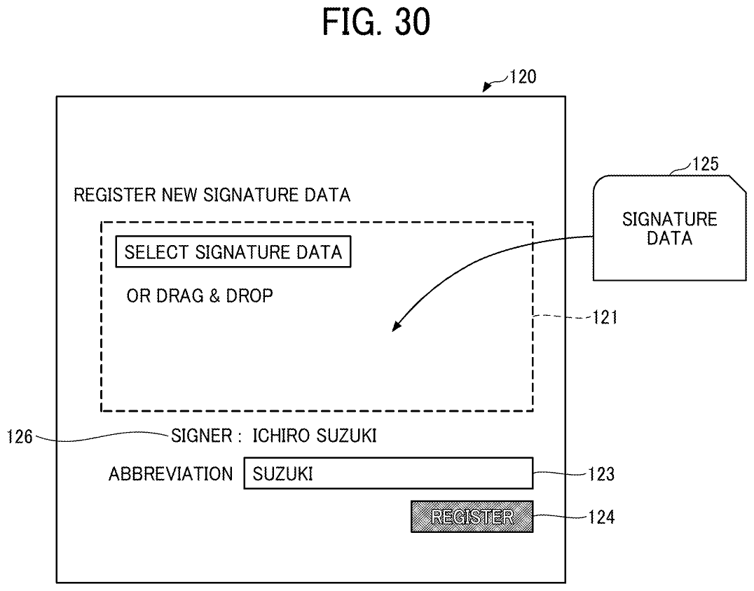

FIG. 30 is a diagram illustrating an example of the electronic signature information registration screen 120 according to the present embodiment. In the following description of FIG. 30, differences from FIG. 10 are mainly described. In FIG. 30, there is no signer field 122, and a signer 126 is displayed when the web server function unit 19 transmits the screen information of the electronic signature information registration screen 120 to the display apparatus 2. The signer 126 indicates a name of the user specified by the user logging in to the display apparatus 2 from the terminal device 30.

In this way, the name of the login user is automatically set to the signer 126 of the electronic signature information. Accordingly, when an arbitrary user uses the display apparatus 2 and logs in to the display apparatus 2, the name is specified, so that the display apparatus 2 can generate an electronic signature only when the name coincides with the signer.

Login to Display Apparatus

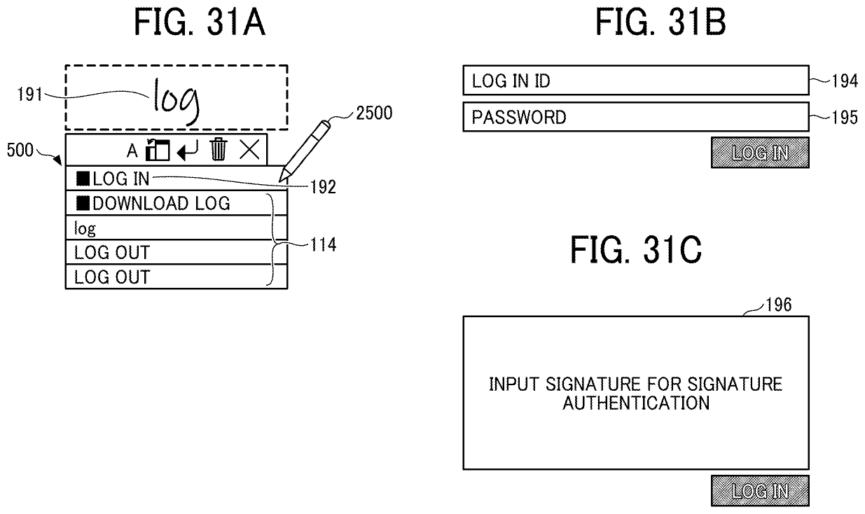

An example of a method in which a user logs in to the display apparatus 2 is described with reference to FIGS. 31 (31A to 31C) and 32 (32A and 32B). FIGS. 31A to 31C are diagrams illustrating an operation command displayed by the display apparatus 2 at the time of login. FIG. 31A illustrates an operation command displayed for hand drafted input data 191 input by the user. The user inputs the hand drafted input data 191 for displaying a login command in order to log in. In FIG. 31A, the text converted from “log” that is input by hand drafted input partially matches one the recognition character strings (for example, log in, LOG IN, etc.) associated with the login command in the command definition data. The display control unit 14 displays a login command 192 of “LOG IN.”

As illustrated in FIG. 31B, when the user selects the login command 192, the display control unit 14 displays a user ID field 194 and a password field 195. A placeholder text of “LOG IN ID” is displayed in the user ID field 194. A placeholder text of “PASSWORD” is displayed in the password field 195. The authentication unit 21 compares the registered user ID and password with the input user ID and password, and if they match, the name of the user can be identified.

The display apparatus 2 can use the signature as authentication information. As illustrated in FIG. 31C, when the user selects the login command 192, the display control unit 14 displays a signature input field 196. A placeholder text of “INPUT SIGNATURE FOR SIGNATURE AUTHENTICATION” is displayed in the signature input field 196. The user inputs, by hand drafted input, his or her name in the signature input field 196. The signature of the name of the user is registered in advance in the display apparatus 2 in association with the name. The authentication unit 21 compares a feature amount of the registered signature with a feature amount of the input signature, and can specify the name of the user when a matching degree between the feature amounts is equal to or greater than a threshold.

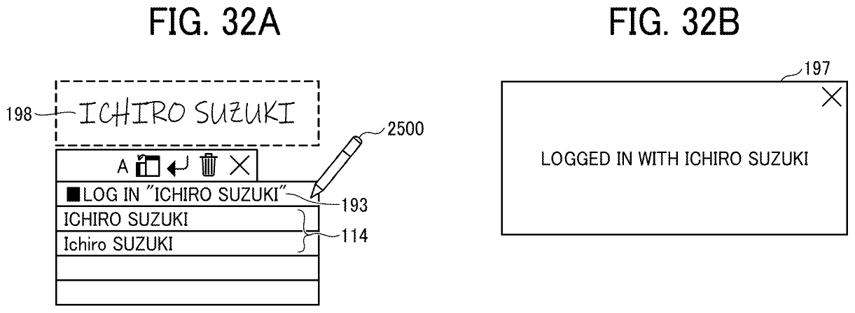

FIGS. 32A and 32B are diagrams illustrating another example of an operation command displayed by the display apparatus 2 at the time of login. As will be described with reference to FIG. 32, when the user logs in, the fields as illustrated in FIGS. 31B and 31C are not necessarily displayed.

FIG. 32A illustrates an operation command displayed for hand drafted input data input by the user. The user inputs hand drafted input data 198 for displaying a login command in order to log in. In FIG. 32A, a feature amount of a signature of “ICHIRO SUZUKI” that is input by hand drafted input is equal to or more than a feature amount of the signature of the user of “ICHIRO SUZUKI” that is set in advance. Accordingly, the display control unit 14 displays a login command 193 of “LOG IN” ICHIRO SUZUKI.”

As illustrated in FIG. 32B, when the user selects the login command 193 with the pen 2500, login is permitted (authentication is successful when the signatures match). The display control unit 14 displays a message 197 indicating that the login is completed.

In this way, the user can log in by simply input his or her name by hand drafted input. By selecting the character string candidate 114 with the pen 2500, the user can input his or her name.

Generating Electronic Signature After Login

When the user logs in to the display apparatus 2, since the user is specified, the user can generate an electronic signature with his or her own electronic signature information by pressing an icon. The electronic signature can also be generated by the same method as in the first to third embodiments.

FIG. 33 is a diagram illustrating an example of an input screen 600 displayed by the display apparatus 2. The input screen 600 mainly includes a hand drafted input area 601, a menu button 602, a zoom pan window display icon 603, a page number display 604, a page navigation display button 605, and an information display area 606.

The hand drafted input area 601 is an area in which the user performs hand drafted input with the pen 2500. The hand drafted input data is automatically converted into a character string. The hand drafted input data may be converted into a character string according to a user operation.

The menu button 602 includes a hand drafted input data line type icon 602a, a line color icon 602b, a cancel icon 602c, a redo icon 602d, a ghost removal icon 602e, an electronic signature icon 602f, a hand drafted input recognition icon 602g, and a delete icon 602h, which are selectable by the user.

The hand drafted input data line type icon 602a is an icon for receiving a change in the line type (thickness, solid line, dotted line, or the like) of the hand drafted input line.

The line color icon 602b is an icon for receiving a change in the color of the hand drafted input data. In the case of electronic paper, since monochrome is mainly used, differences in color are represented by line types.

The cancel icon 602c is an icon for receiving cancellation of the last input operation.

The redo icon 602d is an icon for receiving an operation of executing a canceled operation again.

The ghost removal icon 602e is an icon for receiving an operation with which the display apparatus 2 initializes the entire screen and displays again an object that is displayed before the ghost removal icon 602e is pressed, in order to delete a ghost, which is a trace of a gray object remaining without being erased and generated on the electronic paper.

The electronic signature icon 602f is an icon for receiving a user operation for generating an electronic signature.

The hand drafted input recognition icon 602g is an icon for receiving character recognition on hand drafted input data.

The delete icon 602h is an icon for receiving an operation of deleting a part or all of a page currently displayed (moving to a trash box).

The zoom pan window display icon 603 is an icon for receiving an operation of zooming (enlarging) or panning (reducing) the hand drafted input area.

The page number display 604 indicates a page number for the current hand drafted input data. The page navigation display button 605 is a button for displaying a thumbnail of each page at the right end of the hand drafted input area.

The information display area 606 is an area for displaying today's date 606a, time 606b, an IP address 606c, an SSID 606d, a PIN 606e, and the like. The IP address 606c is an IP address for the terminal device 30 to connect to the display apparatus 2. The SSID 606d is an identifier of an access point provided by the display apparatus 2. The PIN 606e is an encryption key (password) for the terminal device 30 to connect to the access point. The PIN 606e may be displayed separately from the encryption key (password). When the encryption key and the PIN are different, security can be improved.

The user inputs the IP address 606c to the web browser running on the terminal device 30. In addition, the user can transmit the IP address 606c to another user at a remote site, and a remote conference with another display apparatus 2 or a linked display with an adjacent display apparatus 2 can be performed.

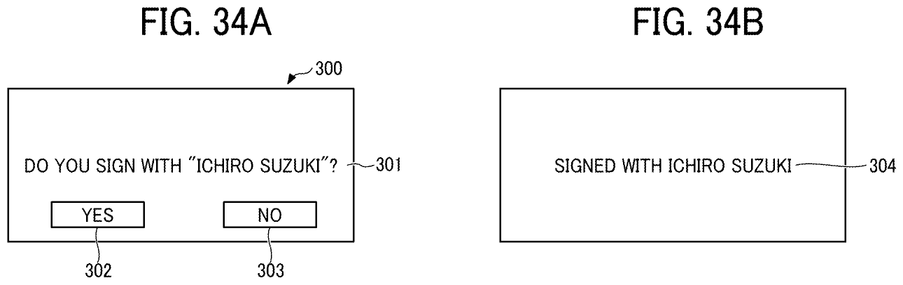

FIGS. 34A and 34B are diagrams illustrating a signature execution dialog 300 displayed when the electronic signature icon 602f is pressed. The signature execution dialog 300 includes a message 301 “DO YOU SIGN WITH” ICHIRO SUZUKI“?,” a YES button 302, and a NO button 303.

“Ichiro Suzuki” is the name of the user who currently logs in. When the user presses the YES button 302, the electronic signature unit 20 generates an electronic signature using electronic signature information having “ICHIRO SUZUKI” as a signer. FIG. 34B is a diagram illustrating a message 304 displayed by the display apparatus 2 that has generated the electronic signature.

As described above, when the electronic signature information is registered, the authenticated signer is also registered, and the user who logs in to the display apparatus 2 can generate the electronic signature by pressing an icon.

Preventing Generation of Electronic Signature Using Electronic Signature Information of Others

The display apparatus 2 to which a user is logs in can prevent from the user currently logs in from generating an electronic signature using electronic signature information of others.

For example, when a user, Tanaka, logs in to the display apparatus 2, and “ICHIRO SUZUKI” is input by hand drafted input and converted into the text, since the name of the user currently logs in and the signer do not match, the check mark 111 is not displayed in FIGS. 14D and 14E, and the signature execution command 113 is not displayed in FIGS. 17A and 19A. In addition, when the user, Tanaka, presses the electronic signature icon 602f, the user, Tanaka, can generate an electronic signature using electronic signature information having “Tanaka” as a signer.

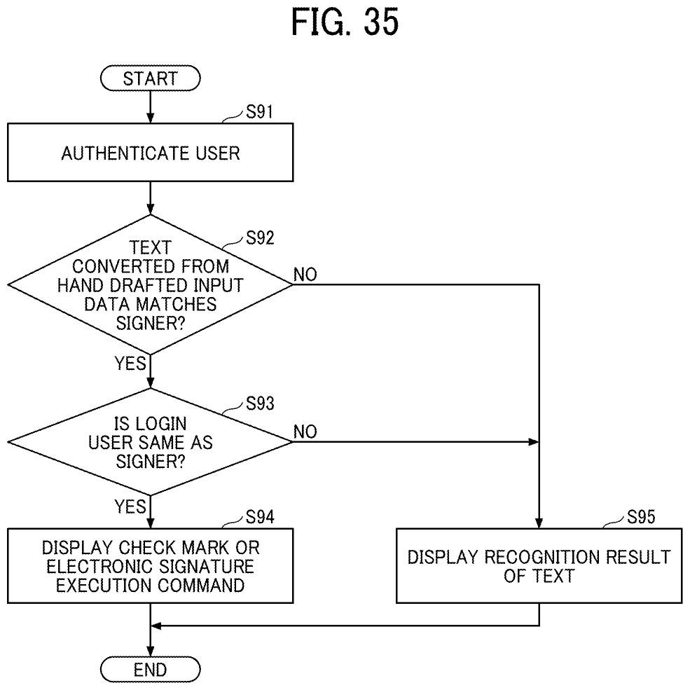

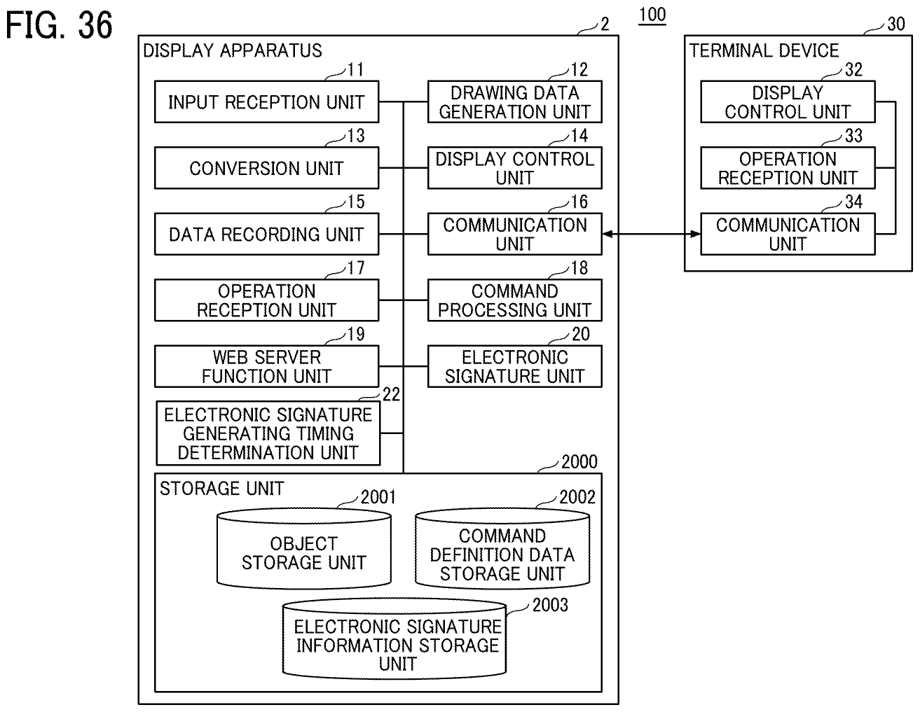

FIG. 35 is a flowchart illustrating an example of a process performed by the display apparatus 2 for generating an electronic signature according to the present embodiment. In the following description of FIG. 35, the user may perform hand drafted input to the signature input field 110 or may perform hand drafted input to an area other than the signature input field.

First, the authentication unit 21 of the display apparatus 2 authenticates the user (S91). The user who is successfully authenticated logs in to the display apparatus 2.

When the user performs hand drafted input, the conversion unit 13 converts hand drafted input data into the text.
(1) A case that the hand drafted input data is input to the signature input field 110. The electronic signature unit 20 determines whether the text corresponding to hand drafted input data input to the signature input field 110 and selected with the operation guide 500 partially matches the signer of the electronic signature information storage unit 2003 or not (S92).

When the determination result in step S92 is Yes, the electronic signature unit 20 determines whether the signer specified in step S92 is same as the login user (user who currently logs in) (S93).
(2) A case that hand drafted input data is input to an area other than the signature input field 110. The following description is given on the assumption that the text converted from the hand drafted input data partially matches the recognition character string of the signature execution command 113. The electronic signature unit 20 determines whether the recognition character string of the signature execution command 113 partially matches the signer of the electronic signature information storage unit 2003 or not (S92).

When the determination result in step S92 is Yes, the electronic signature unit 20 determines whether the signer specified in step S92 is same as the login user (user who currently logs in) (S93).

When the determination result in step S93 is Yes, the display control unit 14 displays the check mark 111 in relation to the signature input field 110 illustrated in FIGS. 14D and 14E or displays the signature execution command 113 in the operation guide 500 as illustrated in FIG. 19A (S94).

When the determination result in step S92 or S93 is No, the display control unit 14 displays a recognition result of the text in the signature input field 110 or displays the character string candidate 114 in the operation guide 500 (S95). In other words, the display control unit 14 does not display the signature execution command 113 for receiving the execution of the electronic signature.

Although the case that the display apparatus 2 generates the electronic signature has been described with reference to FIG. 35, the present embodiment is also applicable to the case that the electronic signature server 171 generates the electronic signature as in the third embodiment. In other words, in step S95, the display control unit 14 does not perform display for receiving execution of electronic signature, and the display apparatus 2 does not request for an electronic signature to the electronic signature server 171.

According to the present embodiment, in addition to the effects of the first to third embodiments, the display apparatus 2 can restrict the user who generates an electronic signature. With this configuration, a user who uses the electronic signature information of another user to generate an electronic signature can be prevented.

### Fifth Embodiment

In the following description of a fifth embodiment, the display apparatus 2 automatically generates an electronic signature. For example, when to attach an electronic signature to an electronic document is mandatory by law, the electronic signature can be prevented from being missed.

Functions

FIG. 36 is a block diagram illustrating an example of functional configurations of the display apparatus 2 and the terminal device 30 according to the present embodiment. In the following description of FIG. 36, differences from FIG. 6 are mainly described.

Display Apparatus

The display apparatus 2 further includes an electronic signature generating timing determination unit 22. The electronic signature generating timing determination unit 22 determines whether it is a timing to automatically generate an electronic signature or not, and requests the electronic signature unit 20 to generate the electronic signature when it is the timing.

Automatically Generating Electronic Signature

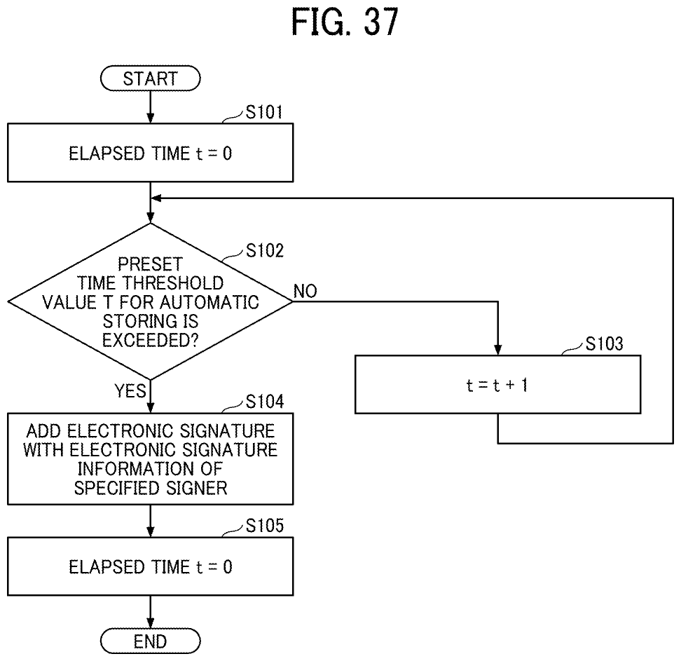

FIG. 37 is a flowchart illustrating an example of a process performed by the display apparatus 2 for automatically generating an electronic signature.

The electronic signature generating timing determination unit 22 initializes an elapsed time t to 0 when an electronic signature is generated last (S101).

The electronic signature generating timing determination unit 22 determines whether the elapsed time t exceeds a preset time threshold value T or not (S102). The time threshold value may be set by a user or a designer.

When the determination result in step S102 is No, the electronic signature generating timing determination unit 22 increases the elapsed time t by a predetermined amount (S103). The predetermined amount may be a value corresponding to the determination cycle of step S103 and may be, for example, about one second.

When the determination result in step S102 is Yes, the electronic signature generating timing determination unit 22 requests the electronic signature unit 20 to generate an electronic signature for the stored data based on the electronic signature information of the signer specified in advance. The electronic signature unit 20 generates the electronic signature for all the stored data stored in the object storage unit 2001 (S104). The signer specified in advance may be an administrator, for example.

Since the electronic signature has been generated, the electronic signature generating timing determination unit 22 initializes the elapsed time t to 0 (S105).

According to the present embodiment, in addition to the effects of the first to fourth embodiments, the display apparatus 2 can automatically generate an electronic signature.

### Sixth Embodiment

In the following description of a sixth embodiment, a remote communication system 310 in which a plurality of display apparatuses 2 performing remote communications shares an electronic signature is described.

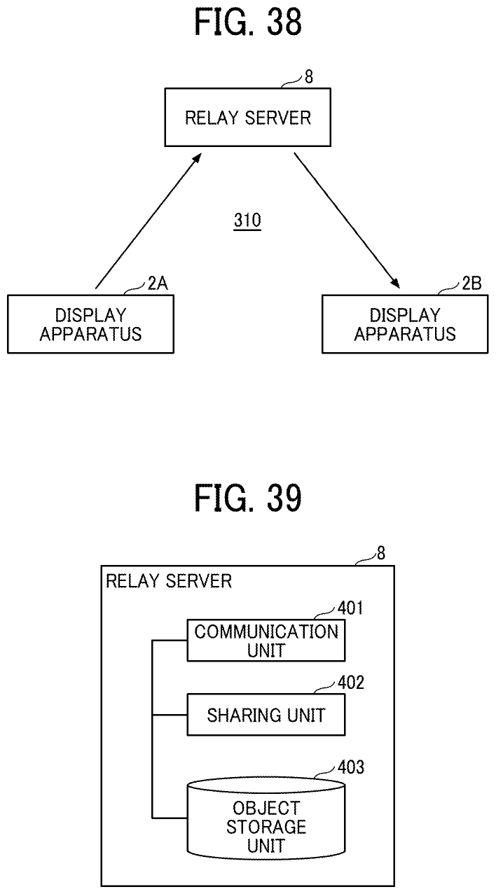

FIG. 38 is a block diagram illustrating a system configuration of a remote communication system 310 according to the present embodiment. The remote communication system 310 includes a relay server 8 and a plurality of display apparatuses 2 (2A and 2B) which can communicate with each other via a network.

The hand drafted input data input to the display apparatus 2A is transmitted to the relay server 8 in real time, and the relay server 8 transmits the hand drafted input data to the display apparatus 2B. The hand drafted input data input to the display apparatus 2B is transmitted to the relay server 8 in real time, and the relay server 8 transmits the hand drafted input data to the display apparatus 2A. In this way, the plurality of display apparatuses 2A and 2B can share the object, and users at remote locations can hold a conference or the like using the object displayed on the each of the plurality display apparatuses 2.

Functions

FIG. 39 is a block diagram illustrating a functional configuration of the relay server 8 according to the present embodiment. A hardware configuration of the relay server 8 may be the same as that of FIG. 5. The relay server 8 includes a communication unit 401, a sharing unit 402, and an object storage unit 403. The communication unit 401 communicates with the display apparatuses 2A and 2B, and transmits an object or an electronic signature from one display apparatus 2 to the other display apparatus 2.

The sharing unit 402 manages the display apparatuses 2 connected to the same session and performs processing for sharing an object between the display apparatuses 2 connected to the same session. The display apparatus 2A and the display apparatus 2B connect to the same session by connecting to a URL issued by the relay server 8. The sharing unit 402 of the relay server 8 shares an object such as hand drafted input data between the plurality of display apparatuses 2 connected to the same session.

Data transmission and reception may be performed between the display apparatuses 2A and 2B using a communication method such as web real time communication (WebRTC) without using the relay server 8.

The object storage unit 403 stores objects such as hand drafted input data and text together with position information indicating a position on the display 220. The object is associated with a session ID. The session ID is identification information for identifying a session in which the object is shared. The configuration of the object storage unit 403 may be the same as that of the object storage unit 2001 included in the display apparatus 2. However, the configuration of the object storage unit 403 may not include the item of electronic signature.

Sharing Electronic Signature

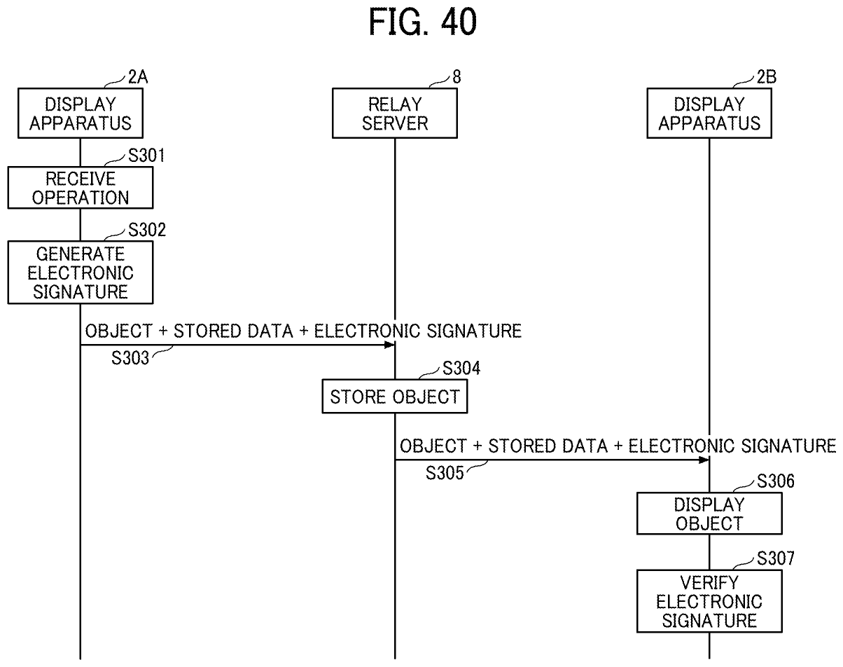

FIG. 40 is a sequence diagram illustrating an example of a process for sharing an object and an electronic signature by the display apparatuses 2A and 2B.

S301, S302: The input reception unit 11 of the display apparatus 2A receives a user operation for generating an electronic signature. The electronic signature unit 20 generates an electronic signature for stored data.

S303: The communication unit 16 of the display apparatus 2A transmits the object (for real-time sharing), the stored data (for example, a PDF file), and the electronic signature (including an electronic certificate) to the relay server 8.

S304: The communication unit 401 of the relay server 8 receives the object, the stored data, and the electronic signature, and the sharing unit 402 stores the object in the object storage unit 403.

S305: The communication unit 401 of the relay server 8 transmits the object, the stored data, and the electronic signature to the display apparatus 2B. The display apparatus 2A at a site A and the display apparatus 2B at a head office are connected to the same session.

S306: The communication unit 16 of the display apparatus 2B receives the object, the stored data, and the electronic signature, and the display control unit 14 displays the object.

S307: The electronic signature unit 20 of the display apparatus 2B verifies the electronic signature. In other words, the electronic signature unit 20 obtains a hash value of the stored data and compares the hash value with a hash value obtained by decrypting the electronic signature with the public key included in the electronic certificate. When the verification is successful, this indicates that the stored data has not been falsified, and the data is stored in the object storage unit 2001. This ensures that the display apparatus 2B stores the same information as the display apparatus 2A.

According to the present embodiment, in addition to the effects of the first to fifth embodiments, the plurality of display apparatuses 2 performing remote communication can share the stored data which is not falsified based on the electronic signature.

### Seventh Embodiment

In the following description of a seventh embodiment, the display apparatus 2 that generates an electronic signature when storing an object in a USB memory or the like is described.

The present embodiment will be described on the assumption that the hardware configurations illustrated in FIGS. 4 and 5 and the functional configuration illustrated in FIG. 6 described in the first embodiment are applicable.

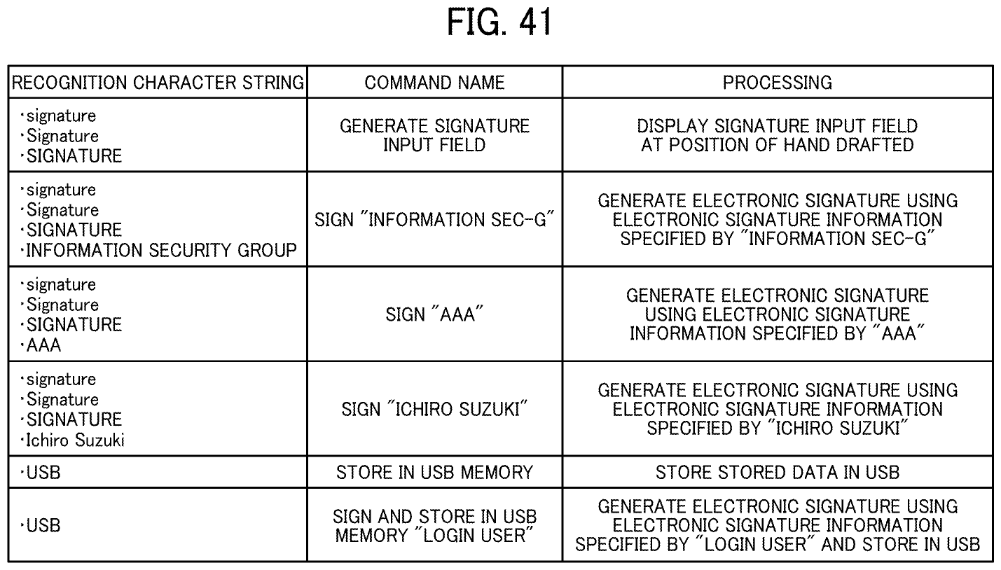

As illustrated in FIG. 41, in the present embodiment, the command definition data is different from that of the first embodiment. FIG. 41 is a diagram schematically illustrating an example of command definition data stored in the command definition data storage unit 2002 according to the present embodiment. In the following description of FIG. 41, differences from FIG. 8 are mainly described. In the command definition data of the present embodiment, “USB” is registered to the recognition character string. The command names are “STORE IN USB MEMORY” and “SIGN AND STORE IN USB MEMORY “LOGIN USER.”” The processing of “STORE IN USB MEMORY” is “STORE STORED DATA IN USB,” and the processing of “SIGN AND STORE IN USB MEMORY “LOGIN USER” is “GENERATE ELECTRONIC SIGNATURE USING ELECTRONIC SIGNATURE INFORMATION SPECIFIED BY “LOGIN USER” AND STORE IN USB.”

Accordingly, when the user inputs “USB” by hand drafted input, the operation commands are displayed in the operation guide 500.

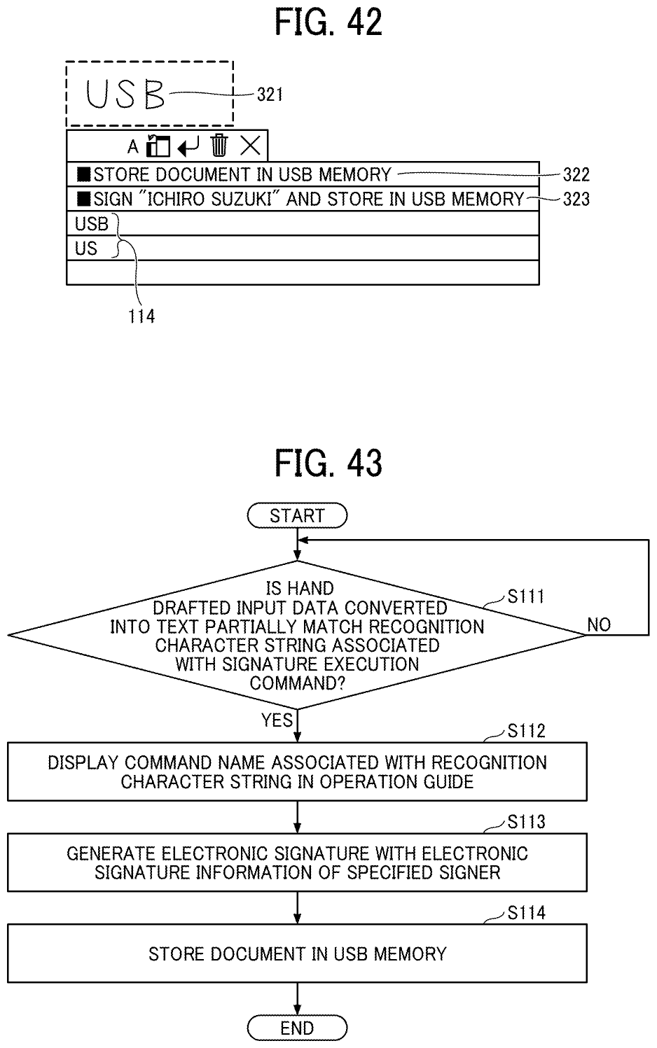

FIG. 42 is a diagram illustrating an example of the signature execution command according to the present embodiment. As illustrated in FIG. 42, a user inputs hand drafted input data 321 in order to store an electronic signature in the USB memory 230. In FIG. 42, the “USB,” which is input by hand drafted input, partially matches the recognition character string (for example, USB or the like) associated with a storing execution command 322 in the command definition data. The display control unit 14 displays the storing execution command 322 of “STORE DOCUMENT IN USB MEMORY” in the operation guide 500.

In substantially the same manner, the “USB,” which is input by hand drafted input, partially matches the recognition character string (for example, USB or the like) associated with a signature execution command 323 in the command definition data. Since the login user is to be used for the signature execution command 323, the display control unit 14 acquires a login user. It is assumed that the current login user is “ICHIRO SUZUKI.” Accordingly, the display control unit 14 causes the operation guide 500 to display the signature execution command 323 “SIGN AND STORE IN USB MEMORY” “ICHIRO SUZUKI.””

When the user selects the signature execution command 323, the electronic signature unit 20 generates an electronic signature using the electronic signature information associated with “ICHIRO SUZUKI” who is the login user.

The storing execution command 322 and the signature execution command 323 in FIG. 42 may be displayed when the USB memory 230 is connected to the display apparatus 2.

FIG. 43 is a flowchart illustrating an example of a process performed by the display apparatus 2 for generating an electronic signature and storing the electronic signature in a USB memory.

First, the electronic signature unit 20 determines whether the hand drafted input data has been converted into the text that partially matches the recognition character string associated with the signature execution command in the command definition data or not (S111). When the determination result in step S111 is Yes, the display control unit 14 causes the operation guide 500 to display the command names (“STORE DOCUMENT IN USB MEMORY” and “SIGN AND STORE IN USB MEMORY “ICHIRO SUZUKI””) associated with the recognition character string (S112).

When the signature execution command 323 “SIGN AND STORE IN USB MEMORY “ICHIRO SUZUKI”” is selected, the electronic signature unit 20 generates an electronic signature using the electronic signature information associated with “ICHIRO SUZUKI” (S113).

The electronic signature unit 20 stores the electronic signature in the USB memory 230 (S114).

According to the present embodiment, in addition to the effects of the first to sixth embodiments, the user can generate and store an electronic signature in an external memory by inputting a name of the external memory by hand drafted input.

Variation

The above-described embodiments are illustrative and do not limit the present invention. Thus, numerous additional modifications and variations are possible in light of the above teachings. For example, elements and/or features of different illustrative embodiments may be combined with each other and/or substituted for each other within the scope of the present invention. Any one of the above-described operations may be performed in various other ways, for example, in an order different from the one described above.

For example, although the display apparatus 2 generates an electronic signature in the above-described embodiments, the display apparatus 2 may simply encrypt an object. When the user inputs, for example, “ENCRYPT” by hand drafted input, an operation command is displayed and the object can be encrypted. The procedure for decrypting may be performed in substantially the same manner.

In the description of the above-described embodiments, the stroke data is mainly converted into English, but the conversion destination language of the stroke data may be another language (Japanese, Chinese, Hindi, Spanish, French, Arabic, Russian, etc.).

In the description of the above-described embodiments, the electronic whiteboard is used as an example to be described but is not limited thereto. The electronic whiteboard may be referred to as, for example, an electronic information board or an interactive board. The present disclosure is applicable to any information processing apparatus having a touch panel. Examples of the information processing apparatus with a touch panel include, but not limited to, a projector, a data output device such as a digital signage, a head up display (HUD), an industrial machine, an imaging device such as a digital camera, a sound collecting device, a medical device, a network home appliance, a laptop PC, a mobile phone, a smartphone, a tablet terminal, a game machine, a personal digital assistant (PDA), a wearable PC, and a desktop PC.

The display apparatus 2 may detect the coordinates of the tip of the pen using ultrasonic waves, although the coordinates of the tip of the pen are detected using the touch panel in the above-described embodiments. Further, the pen transmits an ultrasonic wave together with light emission, and the display apparatus 2 calculates a distance based on an arrival time of the ultrasonic wave. The display apparatus 2 determines the position of the pen based on the direction and the distance, and a projector draws (projects) the trajectory of the pen based on stroke data.

In the example configuration illustrated in FIG. 6, the functions of the display apparatus 2 is divided according to the main functions to facilitate the comprehension of the processing of the display apparatus 2. No limitation to a scope of the present disclosure is intended by how the processes are divided or by the name of the processes. The processing implemented by the display apparatus 2 may be divided into a larger number of processing units depending on the content of the processing. Also, one processing unit can be divided so as to include more processing units.

The functions of the above-described embodiments may be implemented by one or a plurality of processing circuits. In this specification, the “processing circuit or circuitry” in the present specification includes a programmed processor to execute each function by software, such as a processor implemented by an electronic circuit, and devices, such as an application specific integrated circuit (ASIC), a digital signal processor (DSP), a field programmable gate array (FPGA), and conventional circuit modules designed to perform the recited functions.

Embodiments of the present disclosure can provide significant improvements in computer capability and functionality. These improvements allow users to take advantage of computers that provide more efficient and robust interaction with tables that is a way to store and present information on information processing apparatuses.

In addition, embodiments of the present disclosure can provide a better user experience through the use of a more efficient, powerful, and robust user interface. Such a user interface provides a better interaction between humans and machines.

Aspect 1

According to Aspect 1 of the present disclosure, a display apparatus displays hand drafted input data as an object. The display apparatus includes an input reception unit, a conversion unit, a determination unit, a display control unit, and an electronic signature unit.

The input reception unit receives the hand drafted input data.

The conversion unit converts the hand drafted input data into text or a shape.

The determination unit determines whether the converted text is a recognition character string, or the converted shape is a recognition shape. The recognition character string and the recognition shape is set in advance.

The display control unit displays a display component for receiving a user operation for generating an electronic signature based on the recognition character string or the recognition shape, which is set in advance, when the determination unit determines that the converted text is the recognition character string, which is set in advance, or the converted shape is the recognition shape, which is set in advance.

The electronic signature unit generates the electronic signature in response to selection of the display component.

Aspect 2

According to Aspect 2 of the present disclosure, in the display apparatus according to Aspect 1, the input reception unit receives the hand drafted input data input to an area other than an input field. The input field is displayed for generating an electronic signature.

The conversion unit converts the hand drafted input data into the text or the shape.

The display unit display the display component based on the text or the shape.

Aspect 3

According to Aspect 3 of the present disclosure, in the display apparatus according to Aspect 1 or Aspect 2, in a case that the text converted from the hand drafted input data partially matches the recognition character string in the definition data in which the recognition character string set in advance is associated with the display component, the display control unit displays the display component associated with the recognition character string, which partially matches the text.

The display component is for receiving a user operation for generating the electronic signature.

Aspect 4

According to Aspect 4 of the present disclosure, in the display apparatus according to Aspect 3, the recognition character string includes signer information.

In a case that the text converted from the hand drafted input data partially matches the signer information, the display control unit displays the signer information together with the display component.

Aspect 5

According to Aspect 5 of the present disclosure, in the display apparatus according to Aspect 4, in response to receiving selection of the display component displayed together with the signer information, the electronic signature unit obtains electronic signature information associated with the signer information from an electronic signature information storage unit in which the electronic signature information is associated with the signer information, and generates the electronic signature in relation to the object.

Aspect 6

According to Aspect 6 of the present disclosure, the display apparatus according to Aspect 4 further includes an authentication unit to authenticate a user.

In a case that the text converted from the hand drafted input data by the conversion unit partially matches the signer information, and the user who is successfully authenticated by the authentication unit matches the signer information, the display control unit displays the signer information together with the display component.

Aspect 7

According to Aspect 7 of the present disclosure, in the display apparatus according to Aspect 1, in response to the hand drafted input data input to an input field displayed for generating the electronic signature, the display control unit displays the text or the shape in the input field according to conversion performed on the hand drafted input data, and displays an indication that the electronic signature is available.

Aspect 8

According to Aspect 8 of the present disclosure, in the display apparatus according to Aspect 7, the display control unit displays the text or the shape converted from the hand drafted input data by the conversion unit.

In response to the selection of the text, the display control unit displays a message indicating that the electronic signature is available.

Aspect 9

According to Aspect 9 of the present disclosure, in the display apparatus according to Aspect 7 or Aspect 8, in response to the selection of the indication that the electronic signature is available, the electronic signature unit generates the electronic signature in relation to the object using electronic signature information associated with the text converted from the hand drafted input data by the conversion unit.

Aspect 10

According to Aspect 10 of the present disclosure, in the display apparatus according to Aspect 7 or Aspect 8, in a case that the text converted from the hand drafted input data by the conversion unit partially matches the signer information in an electronic signature information storage unit that stores electronic signature information in association with the signer information, the display control unit displays the text converted from the hand drafted input data by the conversion unit in the input field, and the indication that the electronic signature is available.

Aspect 11

According to Aspect 11 of the present disclosure, the display apparatus according to Aspect 10 further includes an authentication unit to authenticate a user.

In a case that the text converted from the hand drafted input data by the conversion unit partially matches the signer information, and the user who is successfully authenticated by the authentication unit matches the signer information, the display control unit displays the text converted from the hand drafted input data by the conversion unit and the indication that the electronic signature is available.

Aspect 12

According to Aspect 12 of the present disclosure, in the display apparatus according to any one of Aspect 7 to Aspect 9, the input reception unit receives the hand drafted input data that is input to an area other than an input field that is displayed for the electronic signature.

The conversion unit converts the hand drafted input data into the text or the shape.

The display control unit displays the input field based on the text or the shape converted from the hand drafted input data input to an area other than the input field.

The input reception unit receives additional hand drafted input data that is input to the input field that is newly displayed.

Aspect 13

According to Aspect 13 of the present disclosure, the display apparatus according to Aspect 1 further includes an authentication unit to authenticate a user.

In response to receiving selection of an icon for receiving a user operation for generating an electronic signature, the electronic signature unit generates the electronic signature in relation to the object based on electronic signature information associated with the user who has been successfully authenticated by the authentication unit in an electronic signature information storage unit that stores the electronic signature information associated with signer information.

Aspect 14

According to Aspect 14 of the present disclosure, in the display apparatus according to any one of Aspect 1 to Aspect 13, the electronic signature unit automatically generates an electronic signature in relation to the object each time an elapsed time exceeds a time threshold.

Aspect 15

According to Aspect 15 of the present disclosure, in the display apparatus according to Aspect 3, in a case that the text converted from the hand drafted input data by the conversion unit partially matches the recognition character string including a name of an external memory set in advance, the display control unit displays another display component for generating the electronic signature and storing the electronic signature in the external memory.

When the selection of the display component is received, the electronic signature unit generates the electronic signature in relation to the object and stores the electronic signature in the external memory.

Aspect 16

According to Aspect 16 of the present disclosure, in the display apparatus according to any one of Aspect 1 to Aspect 15, the electronic signature unit adds time stamp information to the electronic signature.

In a related art, no consideration has been given to convenience in selectively performing between inputting text or a shape and generating an electronic signature both of which are performed by hand drafted input.

According to an embodiment of the present disclosure, convenience in selectively performing between inputting text or a shape and generating an electronic signature both of which are performed by hand drafted input is improved.

According to an embodiment of the disclosure includes a non-transitory recording medium storing a plurality of instructions which, when executed by one or more processors, causes the processors to perform a method. The method includes receiving an input of hand drafted input data. The hand drafted input data is displayed as an object. The further includes method includes converting the hand drafted input data into one of text and a shape, and determining whether the one of the text and the shape is corresponding to a corresponding one of a recognition character string and a recognition shape. The recognition character string and the recognition shape are set in advance. The method further includes displaying, in response to determining that the one of the text and the shape is the corresponding one of the recognition character string and the recognition shape, a display component based on the corresponding one of the recognition character string and the recognition shape. The display component is for receiving a user operation for generating an electronic signature. The method further includes generating the electronic signature in response to receiving selection of the display component.

The functionality of the elements disclosed herein may be implemented using circuitry or processing circuitry which includes general purpose processors, special purpose processors, integrated circuits, application specific integrated circuits (ASICs), digital signal processors (DSPs), field programmable gate arrays (FPGAs), conventional circuitry and/or combinations thereof which are configured or programmed to perform the disclosed functionality. Processors are considered processing circuitry or circuitry as they include transistors and other circuitry therein. In the disclosure, the circuitry, units, or means are hardware that carry out or are programmed to perform the recited functionality. The hardware may be any hardware disclosed herein or otherwise known which is programmed or configured to carry out the recited functionality. When the hardware is a processor which may be considered a type of circuitry, the circuitry, means, or units are a combination of hardware and software, the software being used to configure the hardware and/or processor.

1. A display apparatus, comprising circuitry configured to:
receive an input of hand drafted input data, the hand drafted input data being displayed as an object on a display;
convert the hand drafted input data into one of a text and a shape; and
determine whether the one of the text and the shape corresponds to a corresponding one of a recognition character string and a recognition shape, the recognition character string and the recognition shape being set in advance,
wherein, in a case that the one of the text and the shape corresponds to the corresponding one of the recognition character string and the recognition shape,
the circuitry is further configured to
display, on the display, a display component based on the corresponding one of the recognition character string and the recognition shape, the display component being for receiving a user operation for generating an electronic signature in relation to the object, and
generate the electronic signature in response to receiving selection of the display component.

2. The display apparatus of claim 1, wherein
the circuitry is further configured to receive the hand drafted input data input to an area other than an input field, the input field being displayed for generating an electronic signature.

3. The display apparatus of claim 1, wherein
the circuitry is further configured to display the display component in response to the text partially matching the recognition character string, the recognition character string being associated with the display component in definition data.

4. The display apparatus of claim 1, wherein
the recognition character string includes signer information, and
the circuitry is further configured to display the signer information together with the display component in response to the text partially matching the signer information.

5. The display apparatus of claim 4, wherein,
in response to receiving selection of the display component displayed together with the signer information, the circuitry
obtains, from a memory, electronic signature information stored in association with the signer information, and
generates the electronic signature in relation to the object.

6. The display apparatus of claim 4, wherein
the circuitry is further configured to
authenticate a user, and,
in a case that the text partially matches the signer information, and the user who is successfully authenticated matches the signer information, display the signer information together with the display component.

7. The display apparatus of claim 1, wherein,
in response to the hand drafted input data being input to an input field displayed for generating the electronic signature, the circuitry is configured to
display the one of the text and the shape in the input field according to conversion performed on the hand drafted input data, and
display an indication that the electronic signature is available.

8. The display apparatus of claim 7, wherein
the circuitry is further configured to display the one of the text and the shape converted from the hand drafted input data, and
display, in response to receiving the selection of the one of the text and the shape, a message indicating that the electronic signature is available.

9. The display apparatus of claim 7, wherein,
the circuitry is further configured to generate, in response to receiving the selection of the indication, the electronic signature in relation to the object based on electronic signature information associated with the text.

10. The display apparatus of claim 7, wherein,
in response to the text partially matching signer information stored in association with electronic signature information in a memory, the circuitry is configured to
display the text in the input field, and
display the indication.

11. The display apparatus of claim 10, wherein
the circuitry is further configured to authenticate a user, and,
in a case that the text partially matches the signer information, and the user who is successfully authenticated matches the signer information, display the text and the indication.

12. The display apparatus of claim 1, wherein
the circuitry is further configured to:
receive the hand drafted input data input to an area other than an input field on the display, the input field being displayed for generating an electronic signature;
display the input field based on the one of the text and the shape; and
receive additional hand drafted input data input to the input field newly displayed.

13. The display apparatus of claim 1, wherein
the circuitry is further configured to:
authenticate a user; and
generate, in response to receiving selection of an icon for generating the electronic signature, the electronic signature in relation to the object based on electronic signature information corresponding to the user who has been successfully authenticated, the electronic signature information being stored in association with signer information.

14. The display apparatus of claim 1, wherein
the circuitry is further configured to automatically generate the electronic signature in relation to the object each time an elapsed time exceeds a time threshold.

15. The display apparatus of claim 3, wherein
the character string includes a name of an external memory set in advance, and
the circuitry is further configured to display the display component in response to the text partially matching the recognition character string, the display component being for generating the electronic signature and storing the electronic signature in the external memory, and
in response to receiving the selection of the display component, the circuitry is configured to generate the electronic signature in relation to the object and store the electronic signature in the external memory.

16. The display apparatus of claim 1, wherein
the circuitry is further configured to add time stamp information to the electronic signature.

17. A method for generating an electronic signature, comprising:
receiving an input of hand drafted input data, the hand drafted input data being displayed as an object on a display;
converting the hand drafted input data into one of a text and a shape;
determining whether the one of the text and the shape corresponds to a corresponding one of a recognition character string and a recognition shape, the recognition character string and the recognition shape being set in advance;
displaying, in response to determining that the one of the text and the shape corresponds to the corresponding one of the recognition character string and the recognition shape, a display component based on the corresponding one of the recognition character string and the recognition shape, the display component being for receiving a user operation for generating an electronic signature in relation to the object; and
generating the electronic signature in response to receiving selection of the display component.

18. An electronic signature system, comprising:
a display apparatus including display apparatus circuitry; and
an electronic signature server including electronic signature server circuitry, the display apparatus and the electronic signature server being communicably connected to each other,
the display apparatus circuitry being configured to:
receive an input of hand drafted input data, the hand drafted input data being displayed as an object on a display;
convert the hand drafted input data into one of a text and a shape;
determine whether the one of the text and the shape corresponds to a corresponding one of a recognition character string and a recognition shape, the recognition character string and the recognition shape being set in advance;
display, in response to determining that the one of the text and the shape corresponds to the corresponding one of the recognition character string and the recognition shape, a display component based on the corresponding one of the recognition character string and the recognition shape, the display component being for receiving a user operation for generating an electronic signature in relation to the object; and
transmit, to the electronic signature server, a request for generation of the electronic signature, in response to receiving selection of the display component,
the electronic signature server circuitry being configured to generate the electronic signature in response to receiving the request transmitted from the display apparatus.
